(19) United States
(12) Patent Application Publication
(10) Pub. No.: US 2019/0178323 A1
(43) Pub. Date: Jun. 13, 2019

(54) VIBRATION DAMPING APPARATUS

(71) Applicant: AISIN AW CO., LTD., Anjo-shi, Aichi-ken (JP)

(72) Inventors: Kazuyoshi ITO, Tsushima (JP); Yoichi OI, Ama (JP); Masaki WAJIMA, Nagoya (JP); Hiroki NAGAI, Anjo (JP); Takao SAKAMOTO, Anjo (JP)

(73) Assignee: AISIN AW CO., LTD., Anjo-shi, Aichi-ken (JP)

(21) Appl. No.: 16/323,702

(22) PCT Filed: Sep. 29, 2017
(86) PCT No.: PCT/JP2017/035692

§ 371 Date: Feb. 6, 2019

(30) Foreign Application Priority Data
Sep. 30, 2016 (JP) 2016-193627

(51) Int. Cl. F16F 1/10; F16F 1/12; F16F 15/133; F16F 15/14; F16H 45/02

(52) U.S. Cl. CPC F16F 1/10; F16F 1/12; B60G 2204/1242; F16F 15/14; F16H 45/02; F16F 15/133

(57) ABSTRACT

A vibration damping apparatus that includes a plurality of rotational elements including an input to which a torque from an engine is transferred, and an output; a first torsional stiffness mechanism arranged between the input and the output and having a positive torsional stiffness; and a second torsional stiffness mechanism configured to act in parallel to the first torsional stiffness mechanism between the input and the output and having a negative torsional stiffness, wherein the negative torsional stiffness of the second torsional stiffness mechanism increases on a negative side as a rotation speed of the engine increases.

### BACKGROUND

The present disclosure relates to a vibration damping apparatus.

Hitherto, as this type of vibration damping apparatus, there is proposed a vibration damping apparatus including a first spring that is arranged so as to extend in a circumferential direction between an input element to which a torque from an engine is transferred and an output element and has a positive constant stiffness (spring rate), and a second spring that is arranged so as to extend in a radial direction between the input element and the output element and has a negative constant stiffness (spring rate) (see, for example, DE 102010053250 A1). In a state in which the second spring is attached, the second spring is compressed shorter than its equilibrium length, and is stretched in response to relative rotation (displacement) of the two rotational elements coupled via the second spring. In this vibration damping apparatus, the first spring and the second spring are arranged in parallel between the input element and the output element, thereby reducing the stiffness of the vibration damping apparatus.

### SUMMARY

The vibration damping apparatus described above uses the first spring having the positive constant torsional stiffness (spring rate) and the second spring having the negative constant torsional stiffness (spring rate). Therefore, the overall torsional stiffness (combined spring rate) of the first spring and the second spring is constant irrespective of the rotation speed of the input element. This limits a rotation speed range in which high vibration damping performance can be exerted.

An exemplary aspect of the disclosure extends a rotation speed range in which high vibration damping performance can be exerted for a rotational element to which a torque from an engine is transferred.

A first vibration damping apparatus disclosed herein is summarized as follows. The first vibration damping apparatus is a vibration damping apparatus having a plurality of rotational elements including an input to which a torque from an engine is transferred, and an output. The vibration damping apparatus includes a first torsional stiffness mechanism arranged between the input and the output and having a positive torsional stiffness, and a second torsional stiffness mechanism configured to act in parallel to the first torsional stiffness mechanism between the input and the output and having a negative torsional stiffness. The negative torsional stiffness of the second torsional stiffness mechanism increases on a negative side as a rotation speed of the engine increases.

In the first vibration damping apparatus disclosed herein, the first torsional stiffness mechanism having the positive torsional stiffness and the second torsional stiffness mechanism having the negative torsional stiffness act in parallel between the input to which the torque from the engine is transferred and the output. Thus, the overall torsional stiffness of the plurality of torsional stiffness mechanisms including the first torsional stiffness mechanism and the second torsional stiffness mechanism (corresponding to a combined spring rate in a case of springs) can be reduced. Further, the negative torsional stiffness of the second torsional stiffness mechanism increases on the negative side as the rotation speed of the engine increases. Thus, the overall torsional stiffness of the plurality of torsional stiffness mechanisms can appropriately change in response to the rotation speed of the engine. As a result, it is possible to extend the rotation speed range in which high vibration damping performance can be exerted for the input to which the torque from the engine is transferred.

A second vibration damping apparatus disclosed herein is summarized as follows. The second vibration damping apparatus is a vibration damping apparatus configured to damp a vibration of a rotational element to which a torque from an engine is transferred. The vibration damping apparatus includes a first torsional stiffness mechanism coupled to the rotational element in a freely rotatable manner and having a positive torsional stiffness, a second torsional stiffness mechanism coupled to the rotational element in a freely rotatable manner and having a negative torsional stiffness, and a coupling mechanism that couples the first torsional stiffness mechanism and the second torsional stiffness mechanism to each other. The torsional stiffness of the second torsional stiffness mechanism increases on a negative side as a rotation speed of the engine increases.

In the second vibration damping apparatus disclosed herein, the first torsional stiffness mechanism coupled in a freely rotatable manner to the rotational element to which the torque from the engine is transferred and having the positive torsional stiffness and the second torsional stiffness mechanism coupled to the rotational element in a freely rotatable manner and having the negative torsional stiffness are coupled to each other via the coupling mechanism. In this structure, it can be considered that the first torsional stiffness mechanism and the second torsional stiffness mechanism act on the rotational element in parallel. Therefore, the overall torsional stiffness of the plurality of torsional stiffness mechanisms including the first torsional stiffness mechanism and the second torsional stiffness mechanism can be reduced. Further, in this structure, when the first torsional stiffness mechanism and the second torsional stiffness mechanism deviate from their positions in a stationary state due to the occurrence of fluctuation in the rotation of the rotational element, a vibration having a phase opposite to that of the vibration transferred from the engine to the rotational element is applied to the rotational element from the vibration damping apparatus so that the first torsional stiffness mechanism may return to its position in the stationary state and the second torsional stiffness mechanism may increase the amount of the deviation. Thus, the vibration of the rotational element can be absorbed (damped). Further, the torsional stiffness of the second torsional stiffness mechanism increases on the negative side as the rotation speed of the engine increases. Thus, the overall torsional stiffness of the plurality of torsional stiffness mechanisms including the first torsional stiffness mechanism and the second torsional stiffness mechanism can appropriately change in response to the rotation speed of the engine. As a result, it is possible to extend the rotation speed range in which high vibration damping performance can be exerted for the rotational element to which the torque from the engine is transferred.

### BRIEF DESCRIPTION OF THE DRAWINGS

FIG. 1 is a schematic structural diagram of a starting apparatus including a damper apparatus disclosed herein.

FIG. 2 is a schematic structural diagram of a main part of the damper apparatus.

FIG. 3 is an explanatory drawing for describing an operation of a torsional stiffness mechanism.

FIG. 4 is an explanatory drawing for describing an operation of a torsional stiffness mechanism.

FIG. 5 is a schematic structural diagram of another damper apparatus disclosed herein.

FIG. 6 is a schematic structural diagram of a starting apparatus including another damper apparatus disclosed herein.

FIG. 7 is a sectional view of the damper apparatus.

FIG. 8 is a front-side elevation of the damper apparatus.

FIG. 9 is an explanatory drawing for describing an operation of a torsional stiffness mechanism.

FIG. 10 is an explanatory drawing illustrating an example of a relationship between a distance and a torsional stiffness.

FIG. 11 is a sectional view of another damper apparatus disclosed herein.

FIG. 12 is a front-side elevation of the damper apparatus.

FIG. 13 is a sectional view of another damper apparatus disclosed herein.

FIG. 14 is a front-side elevation of the damper apparatus.

FIG. 15 is an explanatory drawing illustrating a state in which an angular velocity (rotation speed) of an engine is small and a relative torsion angle between an input-side rotational member and a driven member is zero.

FIG. 16 is an explanatory drawing illustrating a state in which the angular velocity (rotation speed) of the engine is large and the relative torsion angle between the input-side rotational member and the driven member is zero.

FIG. 17 is a schematic structural diagram of an inner spring.

FIG. 18 is a schematic structural diagram of another damper apparatus disclosed herein.

FIG. 19 is a schematic structural diagram of another damper apparatus disclosed herein.

FIG. 20 is a schematic structural diagram of a centrifugal pendulum vibration absorbing apparatus.

FIG. 21 is a schematic structural diagram of the centrifugal pendulum vibration absorbing apparatus.

FIG. 22 is a sectional view of the centrifugal pendulum vibration absorbing apparatus.

FIG. 23 is a schematic structural diagram of a centrifugal pendulum vibration absorbing apparatus.

### DETAILED DESCRIPTION OF EMBODIMENTS

Next, modes for carrying out the disclosure disclosed herein are described with reference to the drawings.

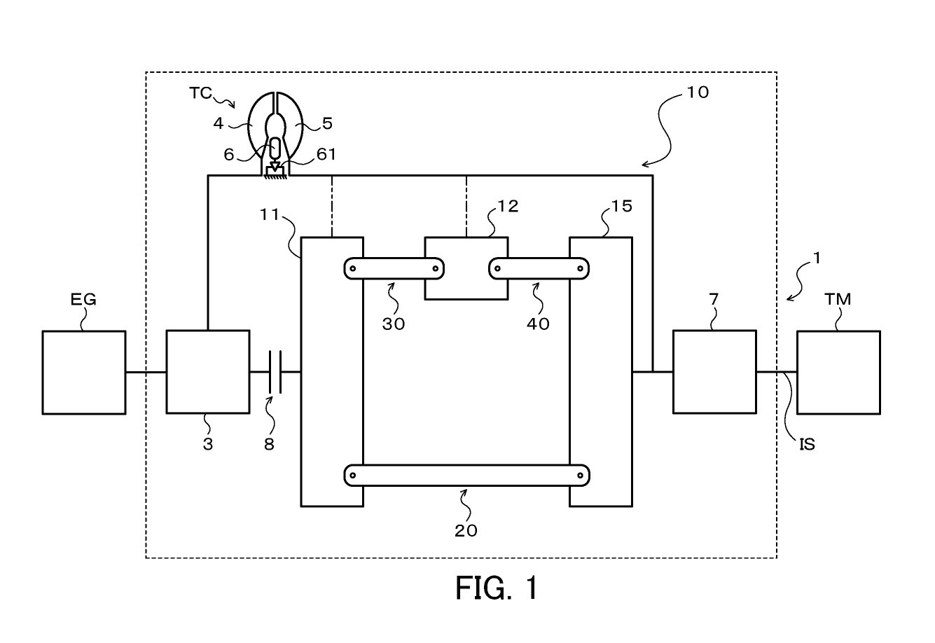

FIG. 1 is a schematic structural diagram of a starting apparatus 1 including a damper apparatus 10 disclosed herein. In the starting apparatus 1 of FIG. 1, the damper apparatus 10 corresponds to a “vibration damping apparatus” disclosed herein. As in the illustration, the starting apparatus 1 is mounted on, for example, a vehicle including an engine (internal combustion engine) EG serving as a drive apparatus. In addition to the damper apparatus 10, the starting apparatus 1 includes a front cover 3 serving as an input member coupled to a crankshaft of the engine EG, a torque converter (fluid transmission apparatus) TC, a damper hub 7 serving as an output member fixed to an input shaft IS of a transmission (power transfer apparatus) TM, a lock-up clutch 8, and the like. The torque converter TC includes a pump impeller (input-side fluid transmission element) 4 fixed to the front cover 3 and configured to rotate together with the front cover 3, a turbine runner (output-side fluid transmission element) 5 rotatable coaxially with the pump impeller 4 and fixed to a driven member 15 of the damper apparatus 10 and the damper hub 7, a stator 6 configured to adjust a flow of hydraulic oil (fluid) from the turbine runner 5 to the pump impeller 4, and a one-way clutch 61 configured to regulate a rotation direction of the stator 6. In place of the torque converter TC, there may be used a structure without the stator 6 and the one-way clutch 61, that is, a structure in which the pump impeller 4 and the turbine runner 5 function as a fluid coupling. Examples of the transmission TM include an automatic transmission (AT), a continuously variable transmission (CVT), a dual clutch transmission (DCT), a hybrid transmission, and a speed reducer. The lock-up clutch 8 executes lock-up for coupling the front cover 3 and the damper hub 7 to each other via the damper apparatus 10, and terminates the lock-up.

In the following description, an “axial direction” is basically an extending direction of a central axis (axis center) of the starting apparatus 1 and the damper apparatus 10 unless otherwise specified. A “radial direction” is basically a radial direction of the starting apparatus 1, the damper apparatus 10, and their rotational elements, that is, an extending direction of a straight line extending from the central axis in a direction orthogonal to the central axis (direction of a radius) unless otherwise specified. A “circumferential direction” is basically a circumferential direction of the starting apparatus 1, the damper apparatus 10, and their rotational elements, that is, a direction along a rotation direction unless otherwise specified.

The damper apparatus 10 includes a driving member (input element) 11, an intermediate member (intermediate element) 12, and the driven member (output element) 15 as the rotational elements. The damper apparatus 10 further includes, as torque transfer elements, a plurality of (for example, two) torsional stiffness mechanisms 20 arranged between the driving member 11 and the driven member 15, a plurality of (for example, two) torsional stiffness mechanisms 30 arranged between the driving member 11 and the intermediate member 12, and a plurality of (for example, two) torsional stiffness mechanisms 40 arranged between the intermediate member 12 and the driven member 15.

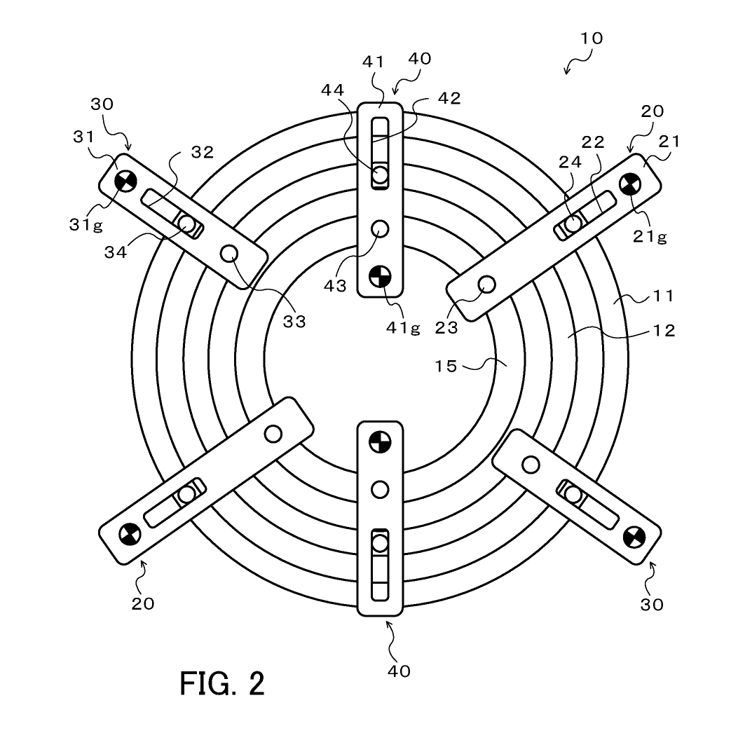

As illustrated in FIG. 2, the driving member 11 is a plate-shaped annular member, and is coupled (fixed) to a lock-up piston of the lock-up clutch 8. Thus, when the lock-up is executed by the lock-up clutch 8, the front cover 3 (engine EG) and the driving member 11 are coupled to each other. The intermediate member 12 is a plate-shaped annular member having a diameter smaller than that of the driving member 11. The driven member 15 is a plate-shaped annular member having a diameter smaller than those of the driving member 11 and the intermediate member 12, and is fixed to the damper hub 7 and the turbine runner 5. The driving member 11, the intermediate member 12, and the driven member 15 are arranged concentrically.

The plurality of torsional stiffness mechanisms 20 are arranged away from each other by 180°, and each include a coupling member 21, a rivet 23 for coupling the coupling member 21 and the driven member 15 to each other in a freely rotatable manner, and a pin 24 for coupling the coupling member 21 and the driving member 11 to each other. The coupling member 21 is formed so as to extend in a given direction, and has a hole 22 extending in the extending direction of the coupling member 21 over a range from a substantial center to one end side. The coupling member 21 is supported on the driven member 15 via the rivet 23 in a freely rotatable manner, and is also supported by the driving member 11 so as to freely rotate and to freely move in the extending direction of the hole 22 (coupling member 21) such that the pin 24 fixed to the driving member 11 is located in the hole 22 of the coupling member 21. Thus, the coupling member 21 has a relationship of a revolute pair with the driven member 15 and a sliding pair with the driving member 11. The coupling member 21 extends in the radial direction when a relative torsion angle (relative displacement) between the driving member 11 and the driven member 15 is zero. A center of gravity 21g of the coupling member 21 is located on a radially outer side with respect to the rivet 23 and the pin 24 on a straight line (in the radial direction when the relative torsion angle between the driving member 11 and the driven member 15 is zero) passing through the rivet 23 (position of the revolute pair with the driven member 15) and the pin 24 (position of the sliding pair with the driving member 11).

The plurality of torsional stiffness mechanisms 30 are arranged away from each other by 180° at positions different from those of the plurality of torsional stiffness mechanisms 20 in the circumferential direction, and each include a coupling member 31, a rivet 33 for coupling the coupling member 31 and the intermediate member 12 to each other in a freely rotatable manner, and a pin 34 for coupling the coupling member 31 and the driving member 11 to each other. The coupling member 31 is formed so as to extend in a given direction, and has a hole 32 extending in the extending direction of the coupling member 31 over a range from a substantial center to one end side. The coupling member 31 is supported on the intermediate member 12 via the rivet 33 in a freely rotatable manner, and is also supported by the driving member 11 so as to freely rotate and to freely move in the extending direction of the hole 32 (coupling member 31) such that the pin 34 fixed to the driving member 11 is located in the hole 32 of the coupling member 31. Thus, the coupling member 31 has a relationship of a revolute pair with the intermediate member 12 and a sliding pair with the driving member 11. The coupling member 31 extends in the radial direction when a relative torsion angle between the driving member 11 and the intermediate member 12 is zero. A center of gravity 31g of the coupling member 31 is located on a radially outer side with respect to the rivet 33 and the pin 34 on a straight line (in the radial direction when the relative torsion angle between the driving member 11 and the intermediate member 12 is zero) passing through the rivet 33 (position of the revolute pair with the intermediate member 12) and the pin 34 (position of the sliding pair with the driving member 11).

The plurality of torsional stiffness mechanisms 40 are arranged away from each other by 180° at positions different from those of the plurality of torsional stiffness mechanisms 20 and the plurality of torsional stiffness mechanisms 30 in the circumferential direction, and each include a coupling member 41, a rivet 43 for coupling the coupling member 41 and the driven member 15 to each other in a freely rotatable manner, and a pin 44 for coupling the coupling member 41 and the intermediate member 12 to each other. The coupling member 41 is formed so as to extend in a given direction, and has a hole 42 extending in the extending direction of the coupling member 41 over a range from a substantial center to one end side. The coupling member 41 is supported on the driven member 15 via the rivet 43 in a freely rotatable manner, and is also supported by the intermediate member 12 so as to freely rotate and to freely move in the extending direction of the hole 42 (coupling member 41) such that the pin 44 fixed to the intermediate member 12 is located in the hole 42 of the coupling member 41. Thus, the coupling member 41 has a relationship of a revolute pair with the driven member 15 and a sliding pair with the intermediate member 12. The coupling member 41 extends in the radial direction when a relative torsion angle between the intermediate member 12 and the driven member 15 is zero. A center of gravity 41g of the coupling member 41 is located on a radially outer side with respect to the rivet 43 and the pin 44 on a straight line (in the radial direction when the relative torsion angle between the intermediate member 12 and the driven member 15 is zero) passing through the rivet 43 (position of the revolute pair with the driven member 15) and the pin 44 (position of the sliding pair with the intermediate member 12).

Next, an operation of the starting apparatus 1 including the damper apparatus 10 is described. As understood from FIG. 1, in the starting apparatus 1, when the lock-up is not executed by the lock-up clutch 8, a torque (power) transferred from the engine EG to the front cover 3 is transferred to the input shaft IS of the transmission TM via a path including the pump impeller 4, the turbine runner 5, and the damper hub 7. When the lock-up is executed by the lock-up clutch 8, the torque (power) transferred from the engine EG to the driving member 11 via the front cover 3 and the lock-up clutch 8 is transferred to the driven member 15, the damper hub 7, and the input shaft IS of the transmission TM via a first torque transfer path including the plurality of torsional stiffness mechanisms 20 and via a second torque transfer path including the plurality of torsional stiffness mechanisms 30, the intermediate member 12, and the plurality of torsional stiffness mechanisms 40.

It is assumed that the lock-up is executed by the lock-up clutch 8 and the damper apparatus 10 coupled to the front cover 3 is rotated by the lock-up clutch 8 along with the rotation of the engine EG. When a relative torsion angle is formed between the driving member 11 and the driven member 15, the torsional stiffness mechanisms 20 operate so as to reduce the relative torsion angle. When a relative torsion angle is formed between the driving member 11 and the intermediate member 12, the torsional stiffness mechanisms 30 operate so as to reduce the relative torsion angle. When a relative torsion angle is formed between the intermediate member 12 and the driven member 15, the torsional stiffness mechanisms 40 operate so as to increase the relative torsion angle. Operations of the torsional stiffness mechanisms 20, 30, and 40 and torsional stiffnesses k1, k2, and k3 are described below.

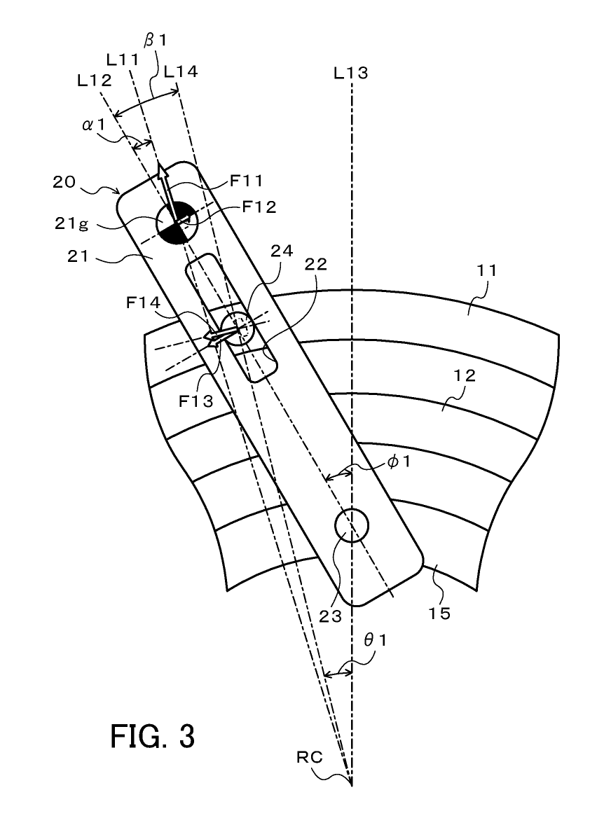

First, the operation of the torsional stiffness mechanism 20 and the torsional stiffness k1 are described with reference to FIG. 3. When the engine EG (damper apparatus 10) rotates, a centrifugal force F11 is applied to the center of gravity 21g of the coupling member 21. The centrifugal force F11 can be represented by Expression (1). In Expression (1), “m1” represents a mass of the coupling member 21, “D11” represents a distance between a rotation center RC of the damper apparatus 10 (driving member 11, intermediate member 12, and driven member 15) and the center of gravity 21g of the coupling member 21, and “Ω” represents an angular velocity of the engine EG. The direction of the centrifugal force F11 is a radially outward direction in a direction of a straight line L11 passing through the rotation center RC of the damper apparatus 10 and the center of gravity 21g of the coupling member 21.

[Math. 1]

F11=m1·D11·Ω′ (1)

When the relative torsion angle between the driving member 11 and the driven member 15 is zero, the coupling member 21 extends in the radial direction (see FIG. 2). Thus, all of the straight line L11 described above, a straight line L12 in the extending direction of the coupling member 21 (straight line passing through the rivet 23 and the pin 24), a straight line L13 passing through the rotation center RC of the damper apparatus 10 and the rivet 23, and a straight line L14 passing through the rotation center RC of the damper apparatus 10 and the pin 24 coincide with each other. Therefore, a component force F12 that is a part of the centrifugal force F11 applied to the center of gravity 21g of the coupling member 21 and is applied in a direction orthogonal to the straight line L12 has a value “0”.

When the relative torsion angle between the driving member 11 and the driven member 15 is not zero, the straight lines L11 to L14 deviate from each other as illustrated in FIG. 3. Thus, the component force F12 that is a part of the centrifugal force F11 applied to the center of gravity 21g of the coupling member 21 and is applied in the direction orthogonal to the straight line L12 can be represented by Expression (2). In Expression (2), “α1” represents an angle between the straight line L11 and the straight line L12. The direction of the component force F12 is a direction in which the relative torsion angle between the driving member 11 and the driven member 15 is reduced (upper right direction in FIG. 3) in the direction orthogonal to the straight line L12. As understood from FIG. 2 and FIG. 3, the center of gravity 21g of the coupling member 21 is located on a radially outermost side when the relative torsion angle between the driving member 11 and the driven member 15 is zero, shifted radially inward as the relative torsion angle between the driving member 11 and the driven member 15 increases, and shifted radially outward as the relative torsion angle between the driving member 11 and the driven member 15 decreases. When the relative torsion angle between the driving member 11 and the driven member 15 is not zero, the component force F12 in the direction in which the relative torsion angle between the driving member 11 and the driven member 15 is reduced in the direction orthogonal to the straight line L12 is generated at the center of gravity 21g of the coupling member 21. Therefore, it can be considered that the torsional stiffness mechanism 20 operates so as to reduce the relative torsion angle between the driving member 11 and the driven member 15 (has a positive restoration force).

[Math. 2]

F12=F11·sin α1 (2)

A force F13 received by the coupling member 21 from the driving member 11 at the position of the pin 24 (position of the sliding pair of the driving member 11 and the coupling member 21) can be represented by Expression (3). In Expression (3), “D12” represents a distance between the rivet 23 and the center of gravity 21g of the coupling member 21, and “D13” represents a distance between the rivet 23 and the pin 24. The direction of the force F13 is a direction in which the relative torsion angle between the driving member 11 and the driven member 15 is increased (direction opposite to that of the component force F12 in FIG. 3) in the direction orthogonal to the straight line L12. A component force F14 that is a part of the force F13 received by the coupling member 21 from the driving member 11 at the position of the pin 24 and is applied in the rotation direction of the damper apparatus 10 can be represented by Expression (4). In Expression (4), “β1” represents an angle between the straight line L12 and the straight line L14. The direction of the force F14 is a direction in which the relative torsion angle between the driving member 11 and the driven member 15 is increased (counterclockwise direction in FIG. 3) in the rotation direction of the damper apparatus 10.

$$\begin{matrix}[ Math . 3 ] & \\ F 13 = F 12 \cdot \frac{D 12}{D 13} & ( 3 ) \\ F 14 = F 13 \cdot cos β 1 & ( 4 )\end{matrix}$$

Thus, a torque T1 transferred to the driving member 11 (the side where the relative torsion angle between the driving member 11 and the driven member 15 is reduced is a positive side) can be represented by Expression (5). In Expression (5), “D14” represents a distance between the rotation center RC of the damper apparatus 10 and the pin 24. In Expression (5), a value “1” is used as a coefficient of a right-hand side for the following reason. The direction of the force F13 received by the coupling member 21 from the driving member 11 is determined by a relational expression for a balance of moment on the coupling member 21. Based on the law of reaction, the driving member 11 receives, from the coupling member 21, a force in a direction opposite to that of the force F13 (force in a direction in which the relative torsion angle between the driving member 11 and the driven member 15 is reduced), that is, a positive restoration force. For this reason, the value “1” is used as the coefficient of the right-hand side of Expression (5).

When Expressions (1) to (5) are integrated, the torque T1 can be represented by Expression (6). Assuming that an angle θ1 between the straight line L13 and the straight line L14 is infinitesimal, that is, “sin θ1≈θ1 and cos θ1=1”, the torque T1 can approximate Expression (7). As represented by Expression (7), the torque T1 is proportional to the square of the angular velocity Ω of the engine EG. Therefore, as represented by Expression (8) that is based on Expression (7), it can be considered that the torsional stiffness mechanism 20 has the positive torsional stiffness k1 proportional to the square of the angular velocity Ω of the engine EG.

Next, the operation of the torsional stiffness mechanism 30 and the torsional stiffness k2 is described. The torsional stiffness mechanism 30 is structured similarly to the torsional stiffness mechanism 20 except that the torsional stiffness mechanism 30 is arranged between the driving member 11 and the intermediate member 12 whereas the torsional stiffness mechanism 20 is arranged between the driving member 11 and the driven member 15. Therefore, the torsional stiffness mechanism 30 operates similarly to the torsional stiffness mechanism 20. Thus, it can also be considered that the torsional stiffness mechanism 30 has the positive torsional stiffness k2 proportional to the square of the angular velocity Ω of the engine EG

$$\begin{matrix}[ Math . 4 ] & \\ T 1 = F 14 \cdot D 14 & ( 5 ) \\ T 1 = m 1 \cdot D 11 \cdot {Ω}^{2} \cdot \frac{D 12 \cdot D 14}{D 13} sin α 1 \cdot cos β 1 & ( 6 ) \\ T 1 = m 1 \cdot D 12 \cdot D 15 \cdot {Ω}^{2} \cdot {( \frac{D 14}{D 13} )}^{2} \cdot θ 1 & ( 7 ) \\ k 1 = m 1 \cdot D 12 \cdot D 15 \cdot {Ω}^{2} \cdot {( \frac{D 14}{D 13} )}^{2} & ( 8 )\end{matrix}$$

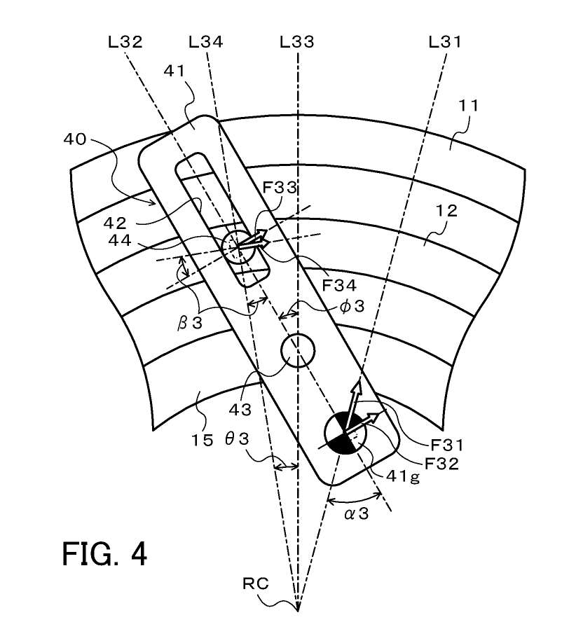

The operation of the torsional stiffness mechanism 40 and the torsional stiffness k3 are described with reference to FIG. 4. When the engine EG (damper apparatus 10) rotates, a centrifugal force F31 is applied to the center of gravity 41g of the coupling member 41. The centrifugal force F31 can be represented by Expression (9). In Expression (9), “m3” represents a mass of the coupling member 41, “D31” represents a distance between the rotation center RC of the damper apparatus 10 and the center of gravity 41g of the coupling member 41, and “Ω” represents the angular velocity of the engine EG as described above. The direction of the centrifugal force F31 is a radially outward direction in a direction of a straight line L31 passing through the rotation center RC of the damper apparatus 10 and the center of gravity 41g of the coupling member 41.

[Math. 5]

F31=m3·D31·Ω³ (9)

When the relative torsion angle between the intermediate member 12 and the driven member 15 is zero, the coupling member 41 extends in the radial direction (see FIG. 2). Thus, all of the straight line L31 described above, a straight line L32 in the extending direction of the coupling member 41 (straight line passing through the rivet 43 and the pin 44), a straight line L33 passing through the rotation center RC of the damper apparatus 10 and the rivet 43, and a straight line L34 passing through the rotation center RC of the damper apparatus 10 and the pin 44 coincide with each other. Therefore, a component force F32 that is a part of the centrifugal force F31 applied to the center of gravity 41g of the coupling member 41 and is applied in a direction orthogonal to the straight line L32 has a value “0”.

When the relative torsion angle between the intermediate member 12 and the driven member 15 is not zero, the straight lines L31 to L34 deviate from each other as illustrated in FIG. 4. Thus, the component force F32 that is a part of the centrifugal force F31 applied to the center of gravity 41g of the coupling member 41 and is applied in the direction orthogonal to the straight line L32 can be represented by Expression (10). In Expression (10), “α3” represents an angle between the straight line L31 and the straight line L32. The direction of the component force F32 is a direction in which the relative torsion angle between the intermediate member 12 and the driven member 15 is increased (upper right direction in FIG. 4) in the direction orthogonal to the straight line L32. As understood from FIG. 2 and FIG. 4, the center of gravity 41g of the coupling member 41 is located on a radially innermost side when the relative torsion angle between the intermediate member 12 and the driven member 15 is zero, shifted radially outward as the relative torsion angle between the intermediate member 12 and the driven member 15 increases, and shifted radially inward as the relative torsion angle between the intermediate member 12 and the driven member 15 decreases. When the relative torsion angle between the intermediate member 12 and the driven member 15 is not zero, the component force F32 in the direction in which the relative torsion angle between the intermediate member 12 and the driven member 15 is increased in the direction orthogonal to the straight line L32 is generated at the center of gravity 41g of the coupling member 41. Therefore, it can be considered that the torsional stiffness mechanism 40 operates so as to increase the relative torsion angle between the intermediate member 12 and the driven member 15 (has a negative restoration force).

[Math. 6]

F32=F31·sin α3 (10)

A force F33 received by the coupling member 41 from the intermediate member 12 at the position of the pin 44 (position of the sliding pair of the intermediate member 12 and the coupling member 41) can be represented by Expression (11). In Expression (11), “D32” represents a distance between the rivet 43 and the center of gravity 41g of the coupling member 41, and “D33” represents a distance between the rivet 43 and the pin 44. The direction of the force F33 is a direction in which the relative torsion angle between the intermediate member 12 and the driven member 15 is reduced (same direction as that of the component force F32 in FIG. 4) in the direction orthogonal to the straight line L32. A component force F34 that is a part of the force F33 received by the coupling member 41 from the intermediate member 12 at the position of the pin 44 and is applied in the rotation direction of the damper apparatus 10 can be represented by Expression (12). In Expression (12), “β3” represents an angle between the straight line L32 and the straight line L34. The direction of the force F34 is a direction in which the relative torsion angle between the intermediate member 12 and the driven member 15 is reduced (clockwise direction in FIG. 4) in the rotation direction of the damper apparatus 10.

$$\begin{matrix}[ Math . 7 ] & \\ F 33 = F 32 \cdot \frac{D 32}{D 33} & ( 11 ) \\ F 34 = F 33 \cdot cos β 3 & ( 12 )\end{matrix}$$

Thus, a torque T3 transferred to the intermediate member 12 (the side where the relative torsion angle between the intermediate member 12 and the driven member 15 is reduced is a positive side) can be represented by Expression (13). In Expression (13), “D34” represents a distance between the rotation center RC of the damper apparatus 10 and the pin 44. In Expression (13), a value (−1) is used as a coefficient of a right-hand side for the following reason. The direction of the force F33 received by the coupling member 41 from the intermediate member 12 is determined by a relational expression for a balance of moment on the coupling member 41. Based on the law of reaction, the intermediate member 12 receives, from the coupling member 41, a force in a direction opposite to that of the force F33 (force in a direction in which the relative torsion angle between the intermediate member 12 and the driven member 15 is increased), that is, a negative restoration force. For this reason, the value (−1) is used as the coefficient of the right-hand side of Expression (13).

When Expressions (9) to (13) are integrated, the torque T3 can be represented by Expression (14). Assuming that an angle θ3 between the straight line L33 and the straight line L34 is infinitesimal, that is, “sin θ3≈θ3 and cos θ3=1”, Expression (14) is transformed by using a distance D35 between the rotation center RC of the damper apparatus 10 and the rivet 43 and the distance D34 between the rotation center RC of the damper apparatus 10 and the pin 44. Then, the torque T3 can approximate Expression (15). As represented by Expression (15), the torque T3 decreases in proportion to the square of the angular velocity Ω of the engine EG (increases as a negative value). Therefore, as represented by Expression (16) that is based on Expression (15), it can be considered that the torsional stiffness mechanism 40 has the negative torsional stiffness k3 proportional to the square of the angular velocity n of the engine EG.

$$\begin{matrix}[ Math . 8 ] & \\ T 3 = - F 34 \cdot D 34 & ( 13 ) \\ T 4 = - m 3 \cdot D 31 \cdot {Ω}^{2} \cdot \frac{D 32 \cdot D 34}{D 33} sin α 3 \cdot cos β 3 & ( 14 ) \\ T 3 = - m 3 \cdot D 32 \cdot D 35 \cdot {Ω}^{2} \cdot {( \frac{D 34}{D 34 - D 35} )}^{2} \cdot θ 3 & ( 15 ) \\ k 3 = - m 3 \cdot D 32 \cdot D 35 \cdot {Ω}^{2} \cdot {( \frac{D 34}{D 34 - D 35} )}^{2} & ( 16 )\end{matrix}$$

The inventors have found the following matters as described in, for example, International Publication No. 2016/021669 (WO 2016/021669) in the structure of the damper apparatus 10, that is, the structure including the first torque transfer path (torsional stiffness mechanism 20) and the second torque transfer path (torsional stiffness mechanism 30, intermediate member 12, and torsional stiffness mechanism 40) between the driving member 11 and the driven member 15. In the structure of the damper apparatus 10, there is an angular frequency ω of a vibration from the engine EG at an anti-resonance point at which the vibration from the engine EG that is transferred from the driving member 11 to the driven member 15 via the first torque transfer path and the vibration from the engine EG that is transferred from the driving member 11 to the driven member 15 via the second torque transfer path are canceled out and the vibration amplitude of the driven member 15 is theoretically zero. The angular frequency ω at the anti-resonance point can be represented by Expression (17). In Expression (17), “k1”, “k2”, and “k3” represent the torsional stiffnesses of the torsional stiffness mechanisms 20, 30, and 40, respectively, and “J′” represents a value calculated from a moment of inertia J of the intermediate member 12, masses m1, m2, and m3 of the coupling members 21, 31, and 41, and distances from the rotation center to the rivets 23, 33, and 43 and the pins 24, 34, and 44. The torsional stiffnesses k1, k2, and k3 of the torsional stiffness mechanisms 20, 30, and 40 and the value J′ are set so that a right-hand side of Expression (17) (specifically, the numerator in the radical sign) is a positive value.

$$\begin{matrix}[ Math . 9 ] & \\ ω = \sqrt{\frac{( k 1 \cdot k 2 + k 2 \cdot k 3 + k 3 \cdot k 1 ) \cdot 2}{{J}^{′} \cdot k 1}} & ( 17 )\end{matrix}$$

As described above, the torsional stiffness k3 of the torsional stiffness mechanism 40 is a negative value. Therefore, in Expression (17), the value “k2·k3” and the value “k3·k1” in the radical sign of the right-hand side are negative values. Thus, the numerator in the radical sign of the right-hand side and furthermore the entire right-hand side can be reduced as compared to a case where the torsional stiffness k3 of the torsional stiffness mechanism 40 is a positive value. Considering a case where the angular frequency ω at the anti-resonance point is set to a constant value, the denominator in the radical sign of the right-hand side of Expression (17) can be reduced, that is, the moment of inertia of the intermediate member 12 can be reduced. As a result, the damper apparatus 10 can be downsized, and the vibration damping performance can be improved.

As described above, the torsional stiffness mechanism 20 has the positive torsional stiffness k1 proportional to the square of the angular velocity Ω of the engine EG, the torsional stiffness mechanism 30 has the positive torsional stiffness k2 proportional to the square of the angular velocity Ω of the engine EG, and the torsional stiffness mechanism 40 has the negative torsional stiffness k3 proportional to the square of the angular velocity Ω of the engine EG. Based on those facts, the rotation speed range of the engine EG in which high vibration damping performance can be exerted can be extended by setting the torsional stiffnesses k1, k2, and k3 of the torsional stiffness mechanisms 20, 30, and 40 and the value J′ so as to increase the angular frequency ω at the anti-resonance point such that the torsional stiffnesses k1, k2, and k3 of the torsional stiffness mechanisms 20, 30, and 40 (and furthermore the overall torsional stiffness) appropriately change as the angular velocity Ω (rotation speed) of the engine EG increases. In particular, the rotation speed range of the engine EG in which the anti-resonance occurs can further be extended by setting the torsional stiffnesses k1, k2, and k3 of the torsional stiffness mechanisms 20, 30, and 40 and the value J′ so that the angular frequency ω at the anti-resonance point substantially equals an angular frequency of the vibration from the engine EG on each occasion.

In the damper apparatus 10 described above, the coupling member 21 of the torsional stiffness mechanism 20 has the relationship of the revolute pair with the driven member 15 and the sliding pair with the driving member 11, but may have a relationship of a sliding pair with the driven member 15 and a revolute pair with the driving member 11. The coupling member 31 of the torsional stiffness mechanism 30 has the relationship of the revolute pair with the intermediate member 12 and the sliding pair with the driving member 11, but may have a relationship of a sliding pair with the intermediate member 12 and a revolute pair with the driving member 11. The coupling member 41 of the torsional stiffness mechanism 40 may have the relationship of the revolute pair with the driven member 15 and the sliding pair with the intermediate member 12.

In the damper apparatus 10 described above, the torsional stiffness mechanism 20 has the positive torsional stiffness k1 proportional to the square of the angular velocity Ω of the engine EG, the torsional stiffness mechanism 30 has the positive torsional stiffness k2 proportional to the square of the angular velocity Ω of the engine EG, and the torsional stiffness mechanism 40 has the negative torsional stiffness k3 proportional to the square of the angular velocity Ω of the engine EG. At least one of the torsional stiffness mechanism 20 and the torsional stiffness mechanism 30 may have a positive torsional stiffness that is constant irrespective of the rotation speed of the engine EG. When the torsional stiffness mechanism 20 or the torsional stiffness mechanism 30 has the constant positive torsional stiffness, an arc coil spring, a straight coil spring, or the like may be used as the torsional stiffness mechanism 20 or the torsional stiffness mechanism 30.

In the damper apparatus 10 described above, the torsional stiffness mechanism 30 having the positive torsional stiffness is arranged between the driving member 11 and the intermediate member 12, and the torsional stiffness mechanism 40 having the negative torsional stiffness is arranged between the intermediate member 12 and the driven member 15. The torsional stiffness mechanism 40 may be arranged between the driving member 11 and the intermediate member 12, and the torsional stiffness mechanism 30 may be arranged between the intermediate member 12 and the driven member 15.

In the damper apparatus 10 described above, the turbine runner 5 of the torque converter TC is fixed to the driven member 15 and the damper hub 7. As indicated by long dashed double-short dashed lines in FIG. 1, the turbine runner 5 may be fixed to the driving member 11 or the intermediate member 12.

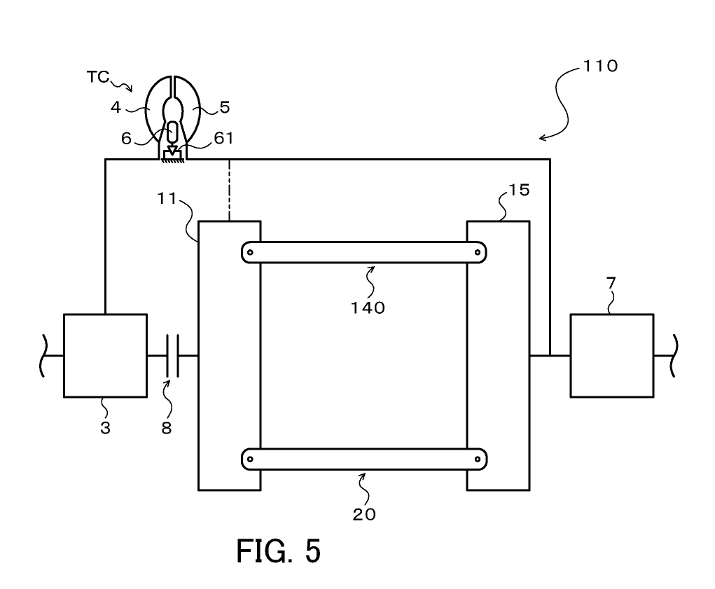

FIG. 5 is a schematic structural diagram of another damper apparatus 110 disclosed herein. The damper apparatus 110 of FIG. 5 corresponds to an apparatus in which the intermediate member 12 is omitted from the damper apparatus 10 described above. The same components of the damper apparatus 110 of FIG. 5 as the components of the damper apparatus 10 are represented by the same reference symbols to omit their detailed description. The damper apparatus 110 of FIG. 5 includes the driving member (input element) 11 and the driven member (output element) 15 as the rotational elements. The damper apparatus 110 further includes, as the torque transfer elements, the plurality of (for example, two) torsional stiffness mechanisms 20 arranged between the driving member 11 and the driven member 15, and a plurality of (for example, two) torsional stiffness mechanisms 140 arranged between the driving member 11 and the driven member 15 in parallel to (configured to act in parallel to) the torsional stiffness mechanisms 20. In the damper apparatus 110, the turbine runner 5 of the torque converter TC may be fixed to the driven member 15 and the damper hub 7 as indicated by a continuous line in FIG. 5, or may be fixed to the driving member 11 as indicated by a long dashed double-short dashed line in FIG. 5. The torsional stiffness mechanism 140 is structured similarly to the torsional stiffness mechanism 40 of the damper apparatus 10, and has a negative torsional stiffness k4 proportional to the square of the angular velocity Ω of the engine EG In the damper apparatus 110, the torsional stiffness mechanism 140 functions similarly to the torsional stiffness mechanism 40 of the damper apparatus 10 of FIG. 1, whereby effects similar to those of the damper apparatus 10 of FIG. 1 can be attained.

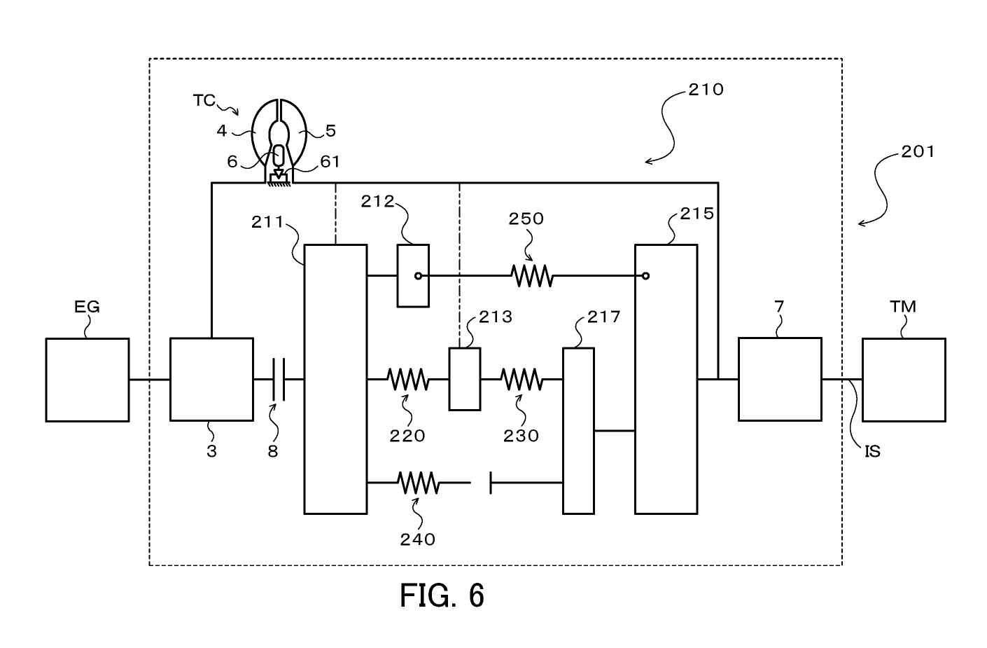

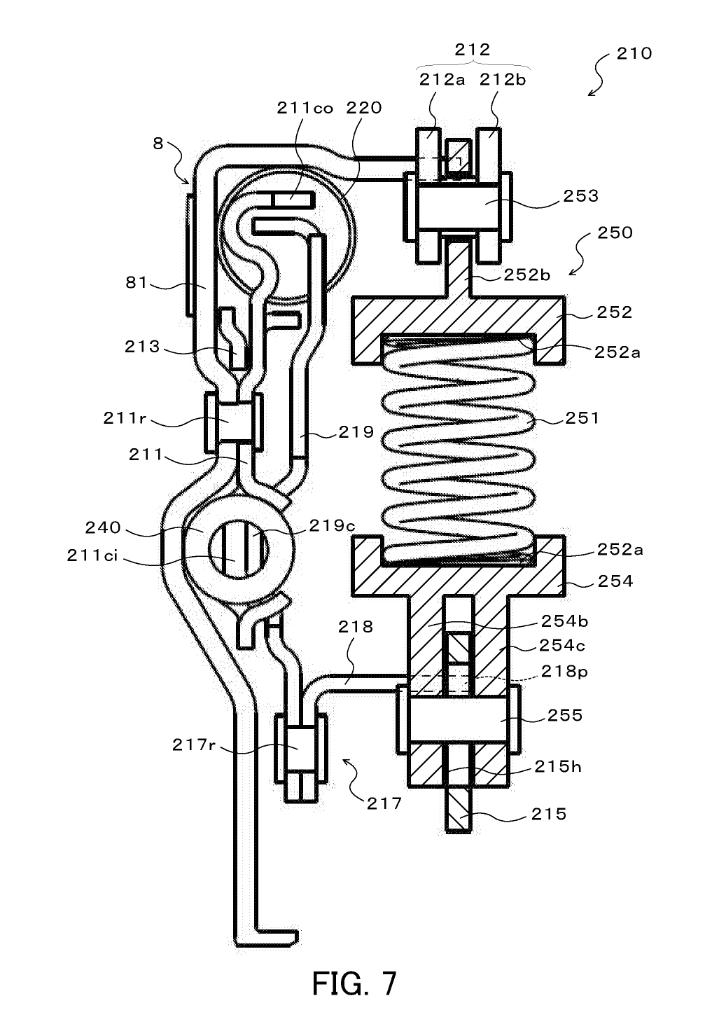

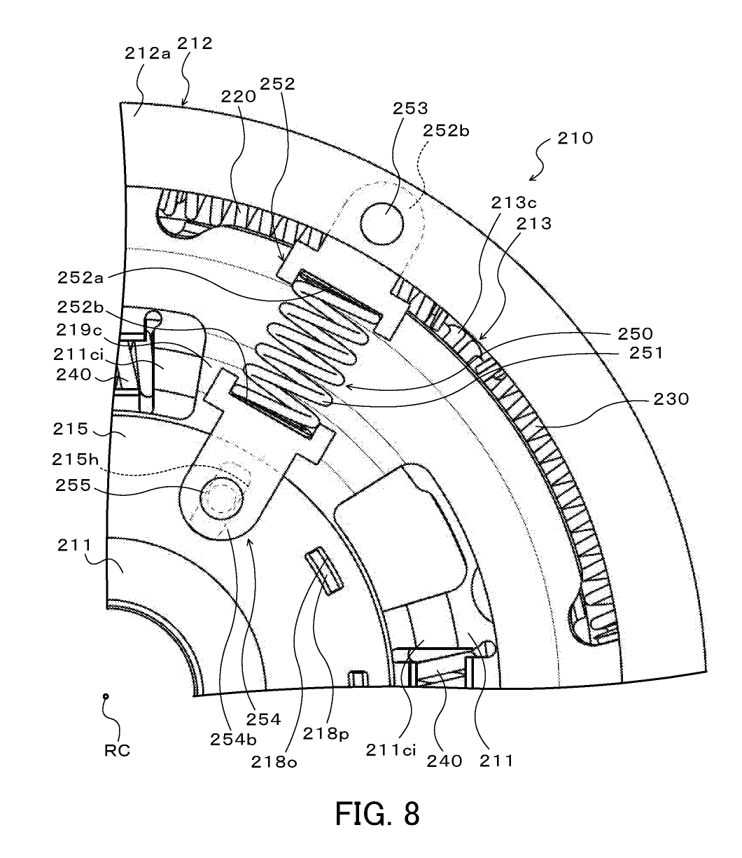

FIG. 6 is a schematic structural diagram of a starting apparatus 201 including another damper apparatus 210 disclosed herein. FIG. 7 is a sectional view of the damper apparatus 210. FIG. 8 is a front-side elevation of the damper apparatus 210. The same components of the starting apparatus 201 and the damper apparatus 210 of FIG. 6 to FIG. 8 as the components of the starting apparatus 1 and the damper apparatus 10 are represented by the same reference symbols to omit their detailed description.

The damper apparatus 210 includes, as the rotational elements, a driving member (input element) 211, an input-side rotational member 212 coupled to the driving member 211, an intermediate member (intermediate element) 213, a driven member (output element) 215, and an output-side rotational member 217 coupled to the driven member 215. The damper apparatus 110 further includes, as the torque transfer elements, a plurality of (for example, four) outer springs (third torsional stiffness mechanisms) 220 arranged between the driving member 211 and the intermediate member 213, a plurality of (for example, four) outer springs (fourth torsional stiffness mechanisms) 230 arranged between the intermediate member 213 and the output-side rotational member 217, a plurality of (for example, four) inner springs (first torsional stiffness mechanisms) 240 arranged between the driving member 211 and the output-side rotational member 217, and a plurality of (for example, four) torsional stiffness mechanisms (second torsional stiffness mechanisms) 250 arranged between the input-side rotational member 216 and the driven member 215.

In this embodiment, a constant pitch straight coil spring, which is formed of a metal material helically wound so as to have an axis center extending straight when no load is applied and in which the pitch of an active coil portion (portion except seats) is a constant pitch, is employed as each of the outer springs 220 and 230 and the inner spring 240. A constant pitch arc coil spring may be employed as at least one of the outer springs 220 and 230 and the inner spring 240.

All of the plurality of outer springs 220 and 230 extend along a circumferential direction of the damper apparatus 210, and are arranged in an outer peripheral region of a fluid chamber defined by the front cover 3 and the pump impeller 4 so that the outer springs 220 and the outer springs 230 are alternately arrayed along the circumferential direction to make pairs (act in series). The plurality of inner springs 240 extend along the circumferential direction of the damper apparatus 210, and are arranged in an inner peripheral region of the fluid chamber so as to be arrayed at intervals along the circumferential direction. In a state in which the damper apparatus 210 is attached (when the relative torsion angle between the two rotational elements coupled via each spring is zero), all of the outer springs 220 and 230 and the inner spring 240 have their equilibrium lengths or are compressed slightly shorter than their equilibrium lengths.

The driving member 211 is coupled to a lock-up piston 81 of the lock-up clutch 8 via a plurality of rivets 211r at intervals in the circumferential direction. The driving member 211 is a plate-shaped annular member, and includes a plurality of (for example, four) outer abutment portions 211co and a plurality of (for example, four) inner abutment portions 211ci. The plurality of outer abutment portions 211co are provided on an outer peripheral portion of the driving member 211 at intervals in the circumferential direction. The plurality of inner abutment portions 211ci are provided on an inner peripheral portion of the driving member 211 with intervals in the circumferential direction.

The input-side rotational member 212 has two plate-shaped annular members 212a and 212b, which are coupled to each other via a plurality of rivets 253 at intervals in the circumferential direction. The input-side rotational member 212 is coupled to the driving member 211 by being coupled to the lock-up piston 81.

The intermediate member 213 is a plate-shaped annular member, and includes a plurality of (for example, four) abutment portions 212c that protrude radially outward at intervals in the circumferential direction. The driven member 215 is a plate-shaped annular member. A plurality of openings 2150 extending along the circumferential direction and a plurality of (for example, four) guide holes 215h extending along the radial direction are formed in the driven member 215 at intervals in the circumferential direction.

The output-side rotational member 217 includes a bottomed tubular member 218 coupled to the driven member 215 and having a bottomed tubular shape, and a plate member 219 coupled to the bottomed tubular member 218. The bottomed tubular member 218 includes protrusions 218p that protrude in the axial direction toward the driven member 215 at intervals in the circumferential direction. The bottomed tubular member 218 and the driven member 215 are coupled to each other such that the protrusions 218p of the bottomed tubular member 218 are fitted to the openings 2150 of the driven member 215. The plate member 219 is coupled to the bottomed tubular member 218 via a plurality of rivets 217r at intervals in the circumferential direction. The plate member 219 includes a plurality of (for example, four) outer abutment portions 219co and a plurality of (for example, four) inner abutment portions 219ci. The plurality of outer abutment portions 219co are provided on an outer peripheral portion of the plate member 219 at intervals in the circumferential direction. The plurality of inner abutment portions 219ci are provided on an inner peripheral portion of the plate member 219 at intervals in the circumferential direction.

In the state in which the damper apparatus 210 is attached (when the relative torsion angle between the two rotational elements coupled via each spring is zero), each outer abutment portion 211co of the driving member 211 abuts against the ends of the outer springs 220 and 230 that are not paired with each other (do not act in series) between those outer springs 220 and 230. Similarly, each outer abutment portion 219co of the plate member 219 of the output-side rotational member 217 abuts against the ends of the outer springs 220 and 230 that are not paired with each other (do not act in series) between those outer springs 220 and 230. Each abutment portion 213c of the intermediate member 213 abuts against the ends of the outer springs 220 and 230 that are paired with each other (act in series) between those outer springs 220 and 230.

Thus, in the state in which the damper apparatus 210 is attached, one end of each outer spring 220 abuts against the corresponding outer abutment portion 211co of the driving member 211 and the corresponding outer abutment portion 219co of the plate member 219, and the other end of each outer spring 220 abuts against the corresponding abutment portion 213c of the intermediate member 213. One end of each outer spring 230 abuts against the corresponding abutment portion 213c of the intermediate member 213, and the other end of each outer spring 230 abuts against the corresponding outer abutment portion 211co of the driving member 211 and the corresponding outer abutment portion 219co of the plate member 219.

In the state in which the damper apparatus 210 is attached, each inner abutment portion 211ci of the driving member 211 abuts against the ends of two inner springs 240 that are adjacent to each other in the circumferential direction between those two inner springs 240. The inner abutment portion 219ci of the plate member 219 is arranged between the two inner springs 240 that are adjacent to each other in the circumferential direction. The inner abutment portion 219ci does not abut against the inner spring 240 when a relative torsion angle between the driving member 211 and the output-side rotational member 217 (plate member 219) is smaller than a predetermined torsion angle as in the state in which the damper apparatus 210 is attached. The inner abutment portion 219ci abuts against the inner spring 240 when the relative torsion angle between the driving member 211 and the output-side rotational member 217 (plate member 219) is equal to or larger than the predetermined torsion angle.

The plurality of torsional stiffness mechanisms 250 are arranged at intervals in the circumferential direction, and are coupled to the input-side rotational member 212 and the driven member 215 so as to extend in the radial direction in the state in which the damper apparatus 210 is attached (when a relative torsion angle between the input-side rotational member 212 and the driven member 215 is zero).

The torsional stiffness mechanism 250 includes a spring (elastic body) 251, an outer retaining member 252 that retains the radially outer end of the spring 251, the rivet 253 described above for coupling the input-side rotational member 212 and the outer retaining member 252 to each other, an inner retaining member 254 that retains the radially inner end of the spring 251, and a rivet 255 for coupling the driven member 215 and the inner retaining member 254 to each other.

A constant pitch straight coil spring, which is formed of a metal material helically wound so as to have an axis center extending straight when no load is applied and in which the pitch of an active coil portion (portion except seats) is a constant pitch, is employed as the spring 251. In the state in which the damper apparatus 210 is attached (when the relative torsion angle between the input-side rotational member 212 and the driven member 215 is zero), the spring 251 is compressed sufficiently shorter than its equilibrium length.

The outer retaining member 252 includes a retaining portion 252a that retains the spring 251, and a protrusion 252b extending from the opposite side of the retaining portion 252a from the spring 251. In a state in which the protrusion 252b of the outer retaining member 252 is inserted between the pair of annular members 212a and 212b of the input-side rotation speed member 212, the rivet 253 couples the pair of annular members 212a and 212b and the protrusion 252b to each other in a freely rotatable manner.

The inner retaining member 254 includes a retaining portion 254a that retains the spring 251, and a pair of protrusions 254b and 254c extending from the opposite side of the retaining portion 254a from the spring 251 with a distance therebetween in the axial direction. In a state in which the driven member 215 is inserted between the pair of protrusions 254b and 254c of the inner retaining member 254, the rivet 255 is inserted into the guide hole 215h of the driven member 215, and couples the driven member 215 and the pair of protrusions 254b and 254c to each other in a freely rotatable manner. The rivet 255 also functions as a mass body, and is movable along the guide hole 215h.

In the damper apparatus 210 structured as described above, when the relative torsion angle between the driving member 211 and the output rotational member 217 (plate member 219) is smaller than the predetermined torsion angle, the driven member 215 is coupled to the driving member 211 via the plurality of outer springs 220, the intermediate member 213, the plurality of outer springs 230, and the output-side rotational member 217, and is also coupled to the driving member 211 via the input-side rotational member 212 and the plurality of torsional stiffness mechanisms 250. When the relative torsion angle between the driving member 211 and the output-side rotational member 217 (plate member 219) is equal to or larger than the predetermined torsion angle, the driven member 215 is coupled to the driving member 211 via the plurality of outer springs 220, the intermediate member 213, the plurality of outer springs 230, and the output-side rotational member 217, also coupled to the driving member 211 via the input-side rotational member 212 and the plurality of torsional stiffness mechanisms 250, and further coupled to the driving member 211 via the plurality of inner springs 240 and the output-side rotational member 217.

Next, an operation of the starting apparatus 201 including the damper apparatus 210 is described. As understood from FIG. 6, in the starting apparatus 201, when the lock-up is not executed by the lock-up clutch 8, the torque (power) transferred from the engine EG to the front cover 3 is transferred to the input shaft IS of the transmission TM via the path including the pump impeller 4, the turbine runner 5, and the damper hub 7.

When the lock-up is executed by the lock-up clutch 8 and when the relative torsion angle between the driving member 211 and the plate member 219 is smaller than the predetermined torsion angle, the torque (power) transferred from the engine EG to the driving member 211 via the front cover 3 and the lock-up clutch 8 is transferred to the driven member 215, the damper hub 7, and the input shaft IS of the transmission TM via a first torque transfer path including the plurality of outer springs 220, the intermediate member 213, the plurality of outer springs 230, and the output-side rotational member 217 and via a second torque transfer path including the input-side rotational member 212 and the plurality of torsional stiffness mechanisms 250. When the lock-up is executed and when the relative torsion angle between the driving member 211 and the plate member 219 is equal to or larger than the predetermined torsion angle, the torque (power) transferred to the driving member 211 is transferred to the driven member 215 via the first torque transfer path, the second torque transfer path, and a third torque transfer path including the plurality of inner springs 240 and the output-side rotational member 217.

In the state in which the damper apparatus 210 is attached (when the relative torsion angle between the two rotational elements coupled via each spring is zero), all of the outer springs 220 and 230 and the inner spring 240 extend along the circumferential direction of the damper apparatus 210, and have their equilibrium lengths or are compressed slightly shorter than their equilibrium lengths. Thus, when the damper apparatus 10 is rotating along with the rotation of the engine EG through the execution of the lock-up and when a relative torsion angle is formed between the two rotational elements on both sides of each of the outer springs 220 and 230 and the inner spring 240, each of the outer springs 220 and 230 and the inner spring 240 operates so as to reduce the relative torsion angle (has a positive restoration force). At this time, each of the outer springs 220 and 230 and the inner spring 240 functions as a spring having a constant spring rate, that is, a positive constant torsional stiffness.

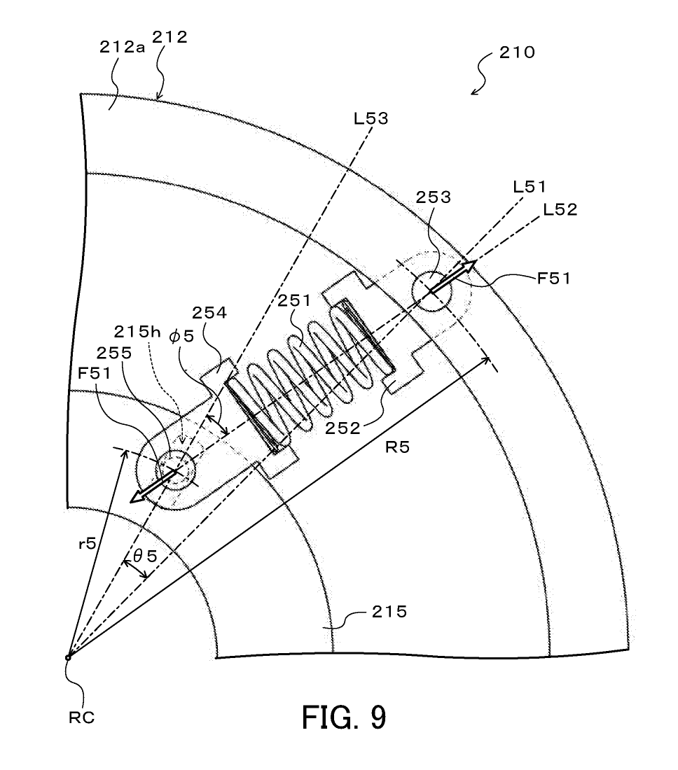

In the state in which the damper apparatus 210 is attached (when the relative torsion angle between the input-side rotational member 212 and the driven member 215 is zero), the torsional stiffness mechanism 250 extends in the radial direction of the damper apparatus 210. In the state in which the damper apparatus 210 is attached, the spring 251 of the torsional stiffness mechanism 250 is compressed sufficiently shorter than its equilibrium length. Thus, when the damper apparatus 10 is rotating along with the rotation of the engine EG through the execution of the lock-up and when a relative torsion angle is formed between the input-side rotational member 212 and the driven member 215, the torsional stiffness mechanism 250 operates so as to increase the relative torsion angle (has a negative restoration force). An operation of the torsional stiffness mechanism 250 and a stiffness k5 are described below with reference to FIG. 9.

In the torsional stiffness mechanism 250, the rivet 253 is held in the rotation direction and the radial direction relative to the input-side rotational member 212, and the rivet 255 is held in the rotation direction but movable in the radial direction relative to the driven member 215.

In the torsional stiffness mechanism 250, when the relative torsion angle between the input-side rotational member 212 and the driven member 215 is zero, the torsional stiffness mechanism 250 extends in the radial direction (see FIG. 8). Thus, all of a straight line L51 passing through the rotation center RC of the damper apparatus 210 and the rivet 253, a straight line L52 in the extending direction of the torsional stiffness mechanism 250 (straight line passing through the rivet 253 and the rivet 255), and a straight line L53 passing through the rotation center RC of the damper apparatus 210 and the rivet 255 coincide with each other. When the relative torsion angle between the input-side rotational member 212 and the driven member 215 is not zero, the extending direction of the torsional stiffness mechanism 250 deviates from the radial direction as illustrated in FIG. 9. Thus, the straight lines L51 to L53 deviate from each other.

A force F51 generated by the spring 251 can be represented by Expression (18) based on the Hooke's law. In Expression (18), “ks5” represents a spring rate of the spring 251, “Ls50” represents an equilibrium length of the spring 251, and “Ls51” represents a current length of the spring 251. A component force F52 that is a part of the force F51 and is applied in the rotation direction at the rivet 255 can be represented by Expression (19). In Expression (19), “ϕ5” represents an angle between the straight line L52 and the straight line L53. Thus, a torque T5 transferred by the spring 251 can be represented by Expression (20). In Expression (20), “r5” represents a distance between the rotation center RC of the damper apparatus 210 and the rivet 255. As described above, the rivet 255 is movable in the radial direction relative to the driven member 215. Therefore, the distance r5 is variable. Specifically, a centrifugal force proportional to the square of the angular velocity Ω (rotation speed) of the engine EG is applied to the rivet 255 that functions as the mass body. Thus, the distance r5 increases as the angular velocity Ω of the engine EG increases. The component force F52 and the torque T5 are a force and a torque in a direction in which the relative torsion angle between the input-side rotational member 212 and the driven member 215 is increased. Thus, it can be said that the torsional stiffness mechanism 250 has a negative restoration force.

[Math. 10]

F51=ks5·(L51−Ls50) (18)

F52=ks5·(Ls51−Ls50)·sin ϕ5 (19)

T5=ks5·(Ls51−Ls50)·sin ϕ5·r5 (20)

When the law of sines and the law of cosines are applied to a triangle having vertices at the rotation center RC of the damper apparatus 210, the rivet 253, and the rivet 255, Expression (21) and Expression (22) are obtained. In Expression (21) and Expression (22), “R5” represents a distance between the rotation center RC of the damper apparatus 210 and the rivet 253, and “05” represents the relative torsion angle between the input-side rotational member 212 and the driven member 215.

$$\begin{matrix}[ Math . 11 ] & \\ \frac{R 5}{sin ( π - φ 5 )} = \frac{L s 51}{sin θ5} & ( 21 ) \\ L s {51}^{2} = r {5}^{2} + R {5}^{2} - 2 \cdot r 5 \cdot R 5 \cdot cos θ5 & ( 22 )\end{matrix}$$

When Expression (21) and Expression (22) are substituted into Expression (20) to erase the current length Ls51 of the spring 251 and the angle+5 between the straight line L52 and the straight line L53, a relationship between the torque T5 transferred by the spring 251 and the relative torsion angle θ5 between the input-side rotational member 212 and the driven member 215 is obtained. In particular, when the relative torsion angle θ5 is infinitesimal, the relationship between the torque T5 and the relative torsion angle θ5 can be represented by Expression (23). Thus, the overall torsional stiffness k5 of the torsional stiffness mechanism 250 can be represented by Expression (24).

$$\begin{matrix}[ Math . 12 ] & \\ T = k s 5 \cdot ( 1 - \frac{L s 50}{R 5 - r 5} ) \cdot r 5 \cdot θ 5 & ( 23 ) \\ k 5 = ks 5 \cdot ( 1 - \frac{L s 50}{R 5 - r 5} ) \cdot r 5 & ( 24 )\end{matrix}$$

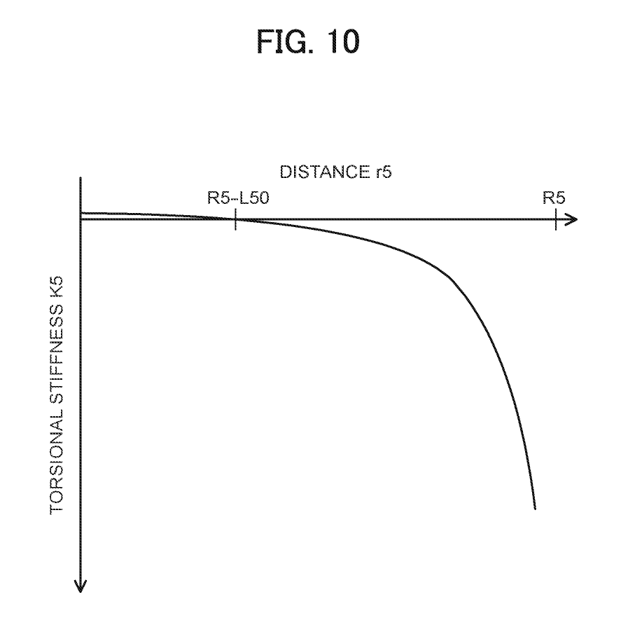

FIG. 10 is an explanatory drawing illustrating an example of a relationship between the distance r5 and the torsional stiffness k5 in Expression (24). As illustrated in FIG. 10, the torsional stiffness k5 has a value “0” when the distance r5 is equal to a difference (R5−Ls50) between the distance R5 and the equilibrium length Ls50 of the spring 251. The torsional stiffness k5 decreases (increases as a negative value) as the distance r5 increases within a range larger than the difference (R5−Ls50) and smaller than the distance R5. Thus, it is demonstrated that the torsional stiffness mechanisms 250 and the guide holes 215h of the driven member 215 should be designed so that the distance r5 is larger than the difference (R5−Ls50) and smaller than the distance R5.

As described above, the distance r5 increases as the angular velocity n (rotation speed) of the engine EG increases. Thus, it can be said that the overall torsional stiffness k5 of the torsional stiffness mechanism 250 decreases (increases on the negative side) as the angular velocity Ω of the engine EG increases. As a result, effects similar to those of the damper apparatus 10 described above can be attained.

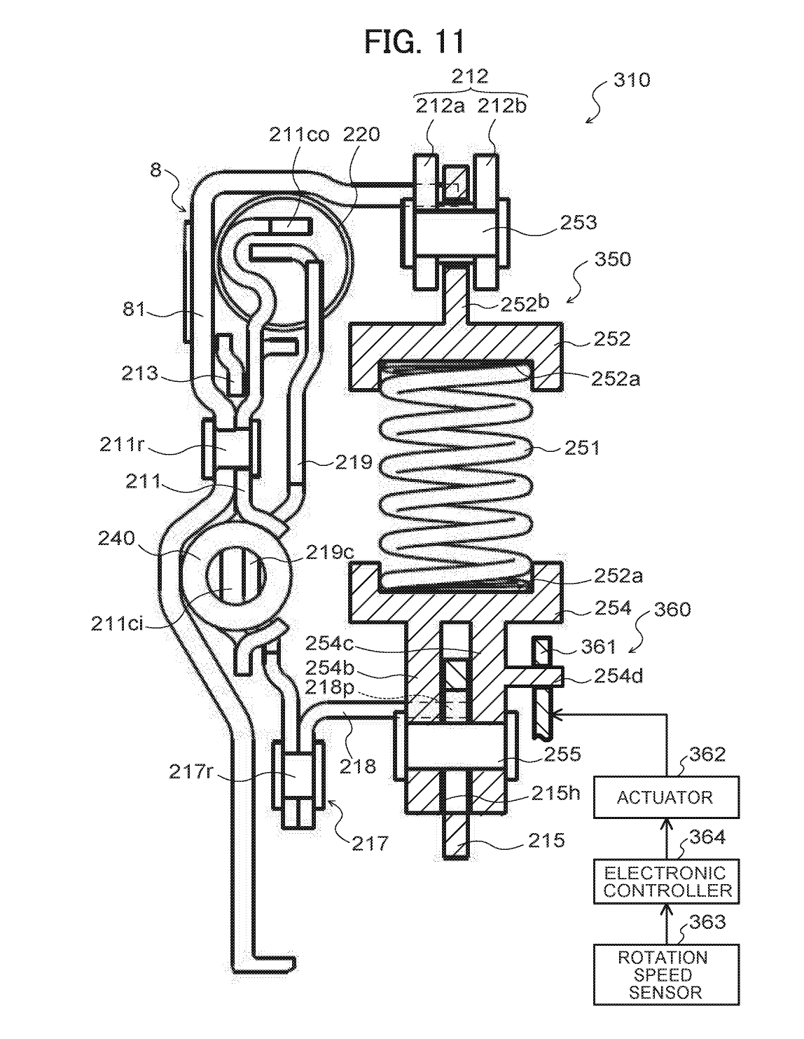

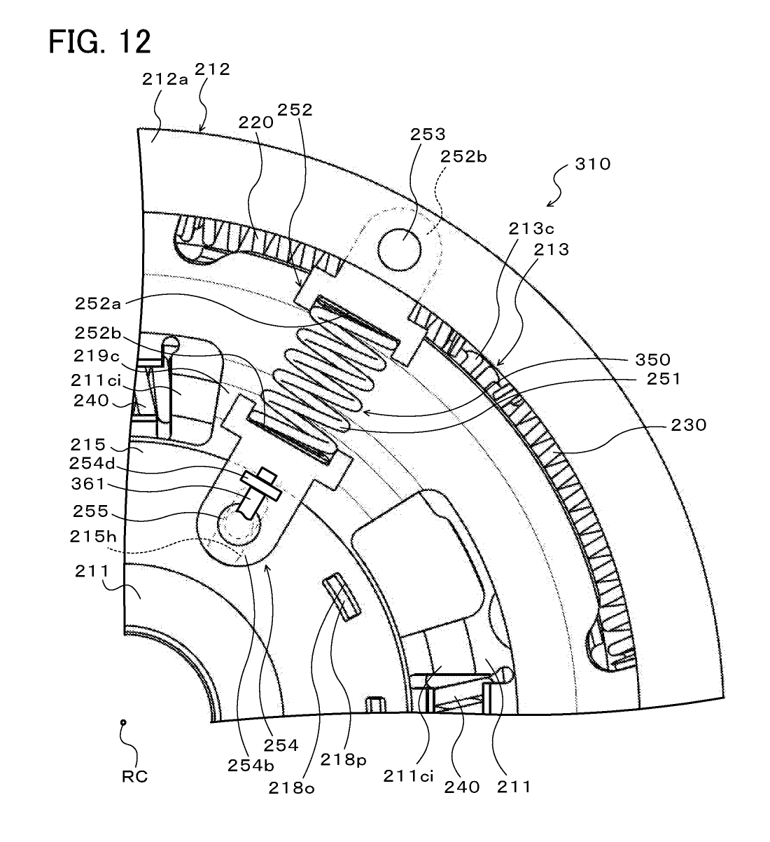

FIG. 11 is a sectional view of another damper apparatus 310 disclosed herein. FIG. 12 is a front-side elevation of the damper apparatus 310. The damper apparatus 310 of FIG. 11 and FIG. 12 corresponds to an apparatus in which the torsional stiffness mechanism 250 of the damper apparatus 210 described above is replaced with a torsional stiffness mechanism 350. The same components of the damper apparatus 310 of FIG. 11 and FIG. 12 as the components of the damper apparatus 210 are represented by the same reference symbols to omit their detailed description.

As illustrated in FIG. 11 and FIG. 12, the torsional stiffness mechanism 350 includes a positional adjuster 360 (see FIG. 11) configured to adjust the position of the rivet 255 (distance r5 described above) by adjusting the position of the inner retaining member 254 in addition to the spring 251, the outer retaining member 252, the rivet 253, the inner retaining member 254, and the rivet 255 that are similar to those of the torsional stiffness mechanism 250. The rivet 255 of the torsional stiffness mechanism 350 only needs to be movable along the guide hole 215 of the driven member 215, and may be lighter in the weight than the rivet 255 of the torsional stiffness mechanism 250.

As illustrated in FIG. 11, the positional adjuster 360 includes a coupling member 361 coupled to the inner retaining member 252, an actuator 362 configured to move the rivet 255 in the radial direction via the coupling member 361 and the inner retaining member 254, a rotation speed sensor 363 configured to detect the rotation speed of the engine EG; and an electronic controller 353 configured to receive the angular velocity Ω (rotation speed) of the engine EG that is input from the rotation speed sensor 351 and to control the actuator 352. A protrusion 254d that protrudes in the axial direction is formed on the outer wall surface of the protrusion 254c of the inner retaining member 254. An opening 361o is formed in the coupling member 361. The inner retaining member 254 and the coupling member 361 are coupled to each other such that the protrusion 254d of the inner retaining member 254 is fitted to the opening 361o of the coupling member 361.

In the positional adjuster 360, the electronic controller 353 controls the actuator 352 so that the inner retaining member 254 and the rivet 255 move radially outward as the angular velocity Ω of the engine EG increases.

An overall stiffness k6 of the torsional stiffness mechanism 360 can be represented by using the spring rate ks5 of the spring 251 (see Expression (24)) similarly to the overall torsional stiffness k5 of the torsional stiffness mechanism 250 of the damper apparatus 210. Thus, when the position of the rivet 255 is adjusted by the positional adjuster 360 as described above, the overall structure k6 of the torsional stiffness mechanism 360 can be decreased (increased on the negative side) as the angular velocity Ω of the engine EG increases similarly to the overall torsional stiffness k5 of the torsional stiffness mechanism 250. As a result, effects similar to those of the damper apparatus 210 can be attained.

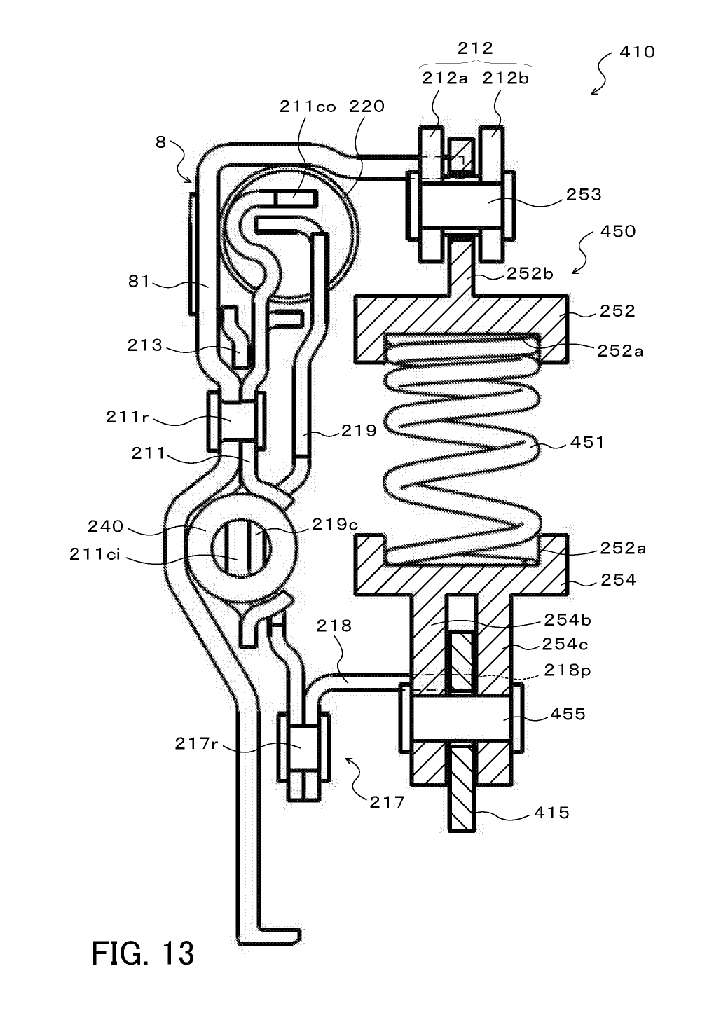

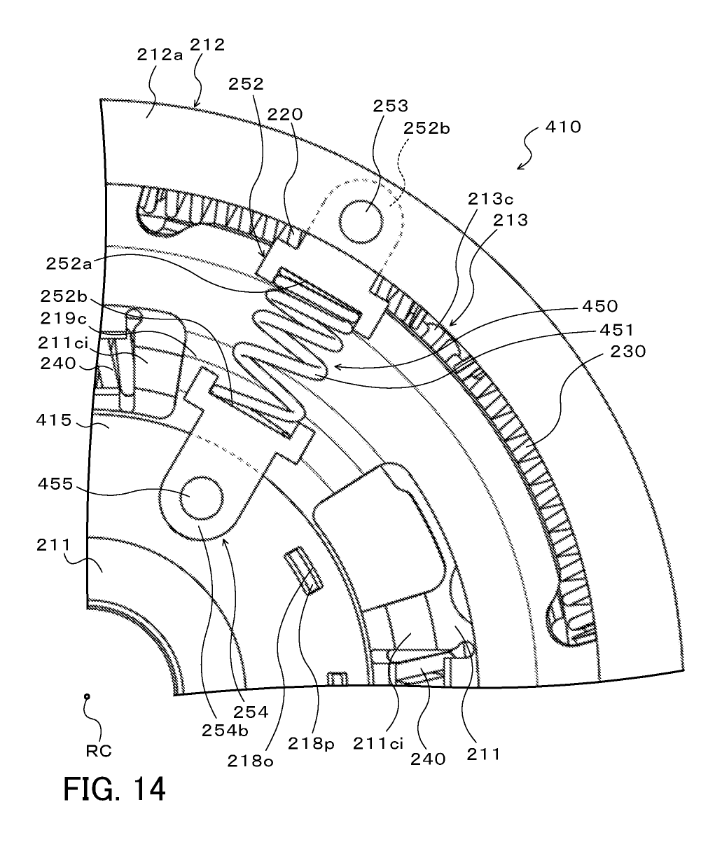

FIG. 13 is a sectional view of another damper apparatus 410 disclosed herein. FIG. 14 is a front-side elevation of the damper apparatus 410. The damper apparatus 310 of FIG. 14 corresponds to an apparatus in which the driven member 215 and the torsional stiffness mechanism 250 of the damper apparatus 210 described above are replaced with a driven member 415 and a torsional stiffness mechanism 450. The same components of the damper apparatus 410 of FIG. 14 as the components of the damper apparatus 210 are represented by the same reference symbols to omit their detailed description.

As illustrated in FIG. 13 and FIG. 14, the driven member 415 is identical to the driven member 215 of the damper apparatus 210 except that the guide hole 215h is not provided. Similarly to the torsional stiffness mechanism 250, the torsional stiffness mechanism 450 is coupled to the input-side rotational member 212 and the driven member 215 so as to extend in the radial direction when a relative torsion angle between the input-side rotational member 212 and the driven member 215 is zero. The torsional stiffness mechanism 450 includes a spring 451, the outer retaining member 252, the rivet 253, the inner retaining member 254, and a rivet 455.

A variable pitch straight coil spring, which is formed of a metal material helically wound so as to have an axis center extending straight when no load is applied and in which the pitch of an active coil portion (portion except seats) is a variable pitch, is employed as the spring 451. In a state in which the damper apparatus 410 is attached, the pitch of the active coil portion of the spring 451 gradually decreases toward the radially outer side, and the spring 451 is compressed shorter than its equilibrium length. The rivet 455 couples the driven member 415 and the pair of protrusions 254b and 254c of the inner retaining member 254 to each other in a freely rotatable manner.

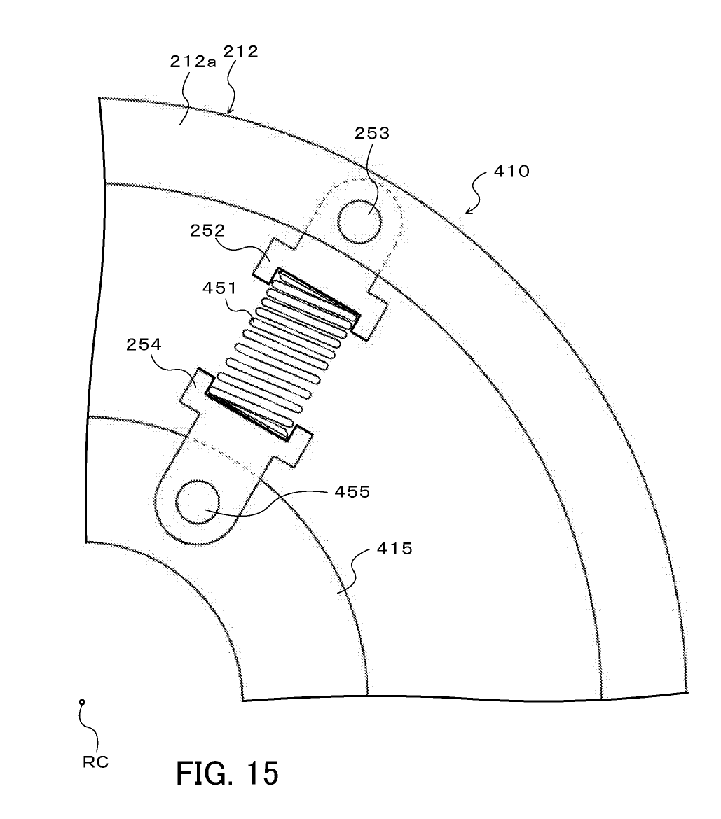

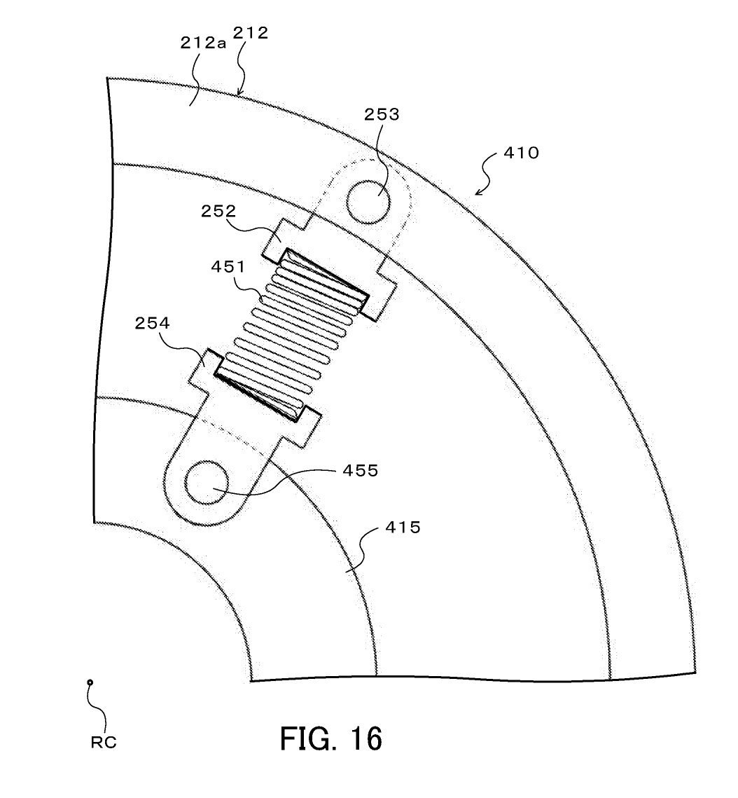

Next, an operation of the torsional stiffness mechanism 450 is described. FIG. 15 is an explanatory drawing illustrating a state in which the angular velocity Ω (rotation speed) of the engine EG is small and the relative torsion angle between the input-side rotational member 212 and the driven member 215 is zero. FIG. 16 is an explanatory drawing illustrating a state in which the angular velocity Ω (rotation speed) of the engine EG is large and the relative torsion angle between the input-side rotational member 212 and the driven member 215 is zero.

As described above, in the state in which the damper apparatus 410 is attached, the pitch of the active coil portion of the spring 451 gradually decreases toward the radially outer side. When the angular velocity Ω of the engine EG is small, a centrifugal force applied to the spring 451 of the torsional stiffness mechanism 450 is small. Therefore, as illustrated in FIG. 15, the degree of closeness of coils to the radially outer side is small in the spring 451 as a whole, and the number of close contact portions of the coils is zero or small in the spring 451 as a whole. Thus, the number of active coils of the spring 451 is large. When the angular velocity Ω of the engine EG is large, the centrifugal force applied to the spring 451 is large. Therefore, as illustrated in FIG. 16, the degree of closeness of the coils to the radially outer side is large in the spring 451 as a whole, and the coils are brought into close contact with each other or the amount of close contact increases in the radially outer portion of the spring 451. Thus, the number of active coils of the spring 451 decreases. That is, as the angular velocity Ω of the engine EG increases, the amount of close contact (number of close contact coils) increases in the spring 451, the number of active coils of the spring 451 decreases, a spring rate ks7 of the spring 451 increases, and an overall torsional stiffness k7 of the torsional stiffness mechanism 450 decreases (increases on the negative side). As a result, effects similar to those of the damper apparatus 210 can be attained.

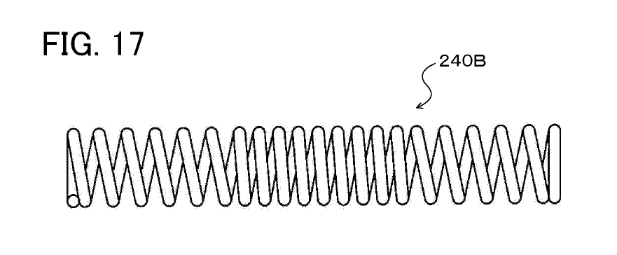

In the damper apparatuses 210, 310, and 410 described above, the constant pitch straight coil spring is employed as the outer spring 240 serving as the torsional stiffness mechanism. As illustrated in FIG. 17, a variable pitch straight coil spring, in which the pitch of an active coil portion (portion except seats) is a variable pitch, may be employed as an inner spring 240B. In this case, the pitch of the active coil portion of the inner spring 240B may gradually decrease toward the center of the inner spring 240B from both ends in its extending direction. If the variable pitch straight coil spring is employed as the outer spring 220 and both ends of the outer spring 220 are supported in the radial direction, when the angular velocity Ω of the engine EG is small, a centrifugal force applied to the outer spring 220 is small. Therefore, the degree of radially outward bulging is small in the vicinity of the center of the outer spring 220 in its extending direction, and the number of close contact portions of coils is zero or small in the inner spring 240B. Thus, the number of active coils of the spring 240B is large. When the angular velocity Ω of the engine EG is large, the centrifugal force applied to the spring 240B is large. Therefore, the degree of radially outward bulging increases in the vicinity of the center of the spring 240B, and its curvature radius decreases. Further, the coils are brought into close contact with each other or the amount of close contact increases in the radially inner portion of the inner spring 240B in the vicinity of the center. Thus, the number of active coils of the inner spring 240B decreases. That is, as the angular velocity Ω of the engine EG increases, the amount of close contact (number of close contact coils) increases in the inner spring 240B, the number of active coils of 240B decreases, and the spring rate of the inner spring 240B increases (the overall torsional stiffness of the first torsional stiffness mechanism increases on the positive side). Although the description is given of the inner spring 240B, the same may apply to the outer springs 220 and 230.

In the damper apparatuses 210, 310, and 410 described above, the turbine runner 5 of the torque converter TC is fixed to the driven member 15 and the damper hub 7. As indicated by long dashed double-short dashed lines in FIG. 6, the turbine runner 5 may be fixed to the driving member 211 or the intermediate member 213.

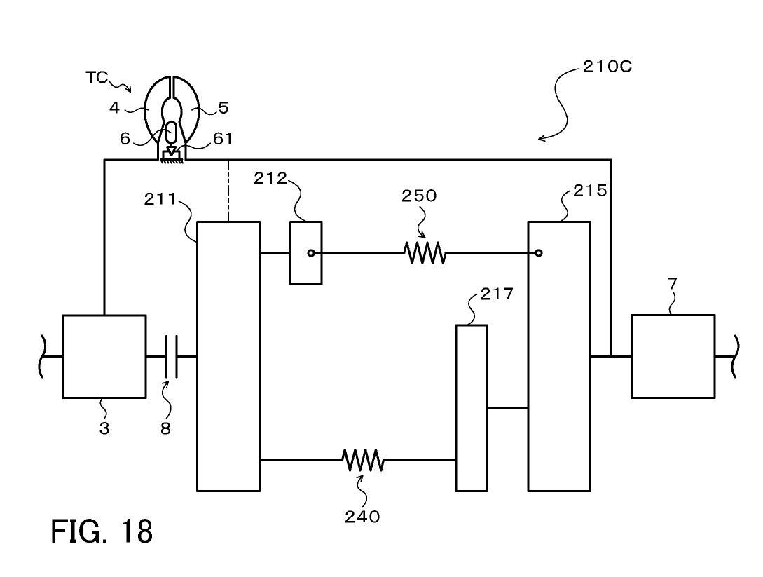

FIG. 18 is a schematic structural diagram of another damper apparatus 510 disclosed herein. The damper apparatus 210C of FIG. 18 corresponds to an apparatus in which the outer springs 220 and 230 and the intermediate member 213 are omitted from the damper apparatus 210 described above and the inner spring 240 constantly operates (functions) irrespective of the relative torsion angle between the driving member 211 and the output-side rotational member 217 (plate member 219). The same components of the damper apparatus 210C of FIG. 18 as the components of the damper apparatus 210 are represented by the same reference symbols to omit their detailed description. The damper apparatus 210C of FIG. 18 includes, as the rotational elements, the driving member (input element) 211, the input-side rotational member 212 coupled to the driving member 211, the driven member (output element) 215, and the output-side rotational member 217 coupled to the driven member 215. The damper apparatus 110 further includes, as the torque transfer elements, the plurality of (for example, four) inner springs (first torsional stiffness mechanisms) 240 arranged between the driving member 211 and the output-side rotational member 217, and the plurality of (for example, four) torsional stiffness mechanisms (second torsional stiffness mechanisms) 250 arranged between the input-side rotational member 216 and the driven member 215. In the damper apparatus 210C, the turbine runner 5 of the torque converter TC may be fixed to the driven member 15 and the damper hub 7 as indicated by a continuous line in FIG. 18, or may be fixed to the driving member 11 as indicated by a long dashed double-short dashed line in FIG. 18. Also in the damper apparatus 210, effects similar to those of the damper apparatus 210 can be attained.

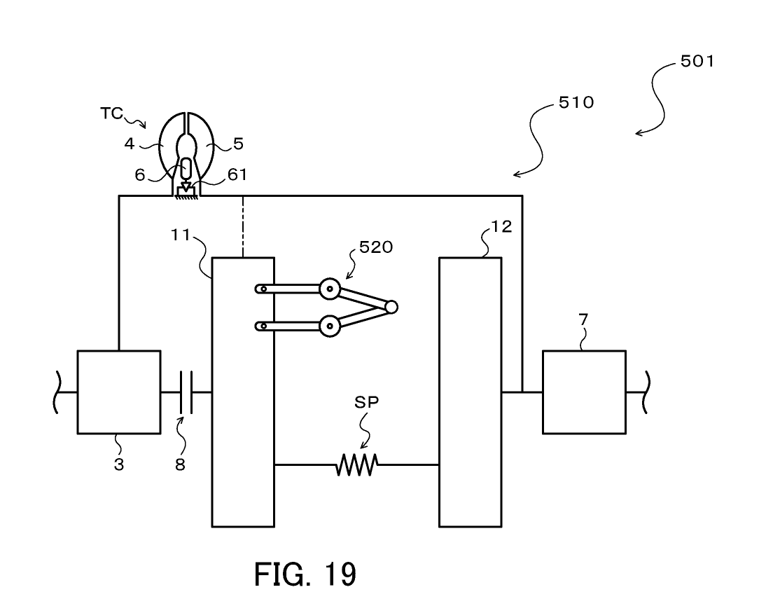

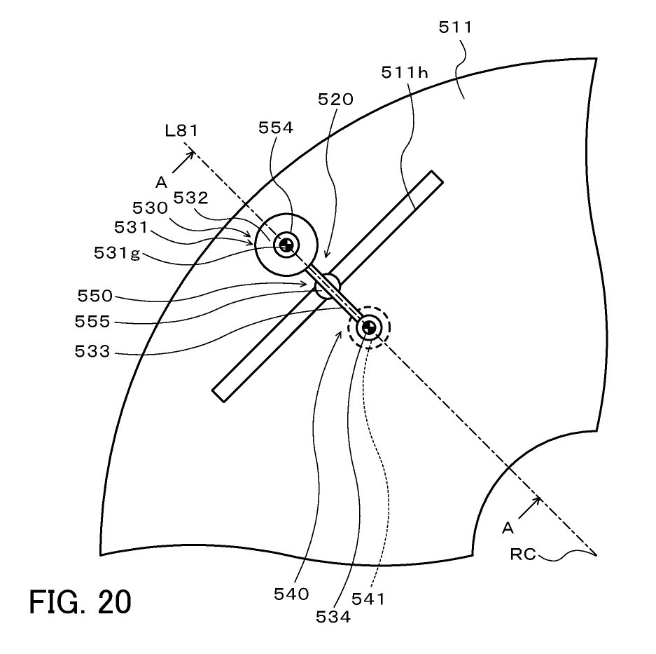

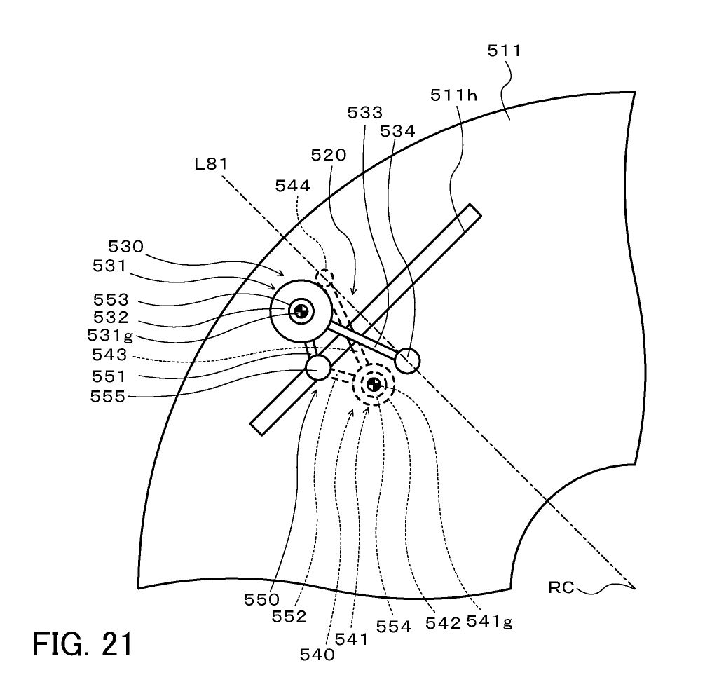

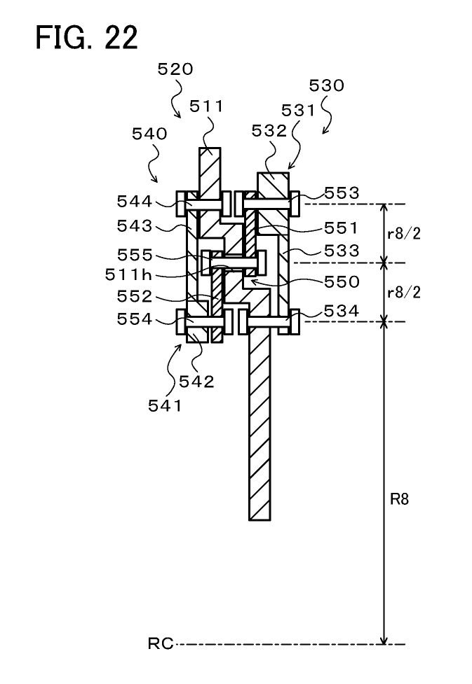

FIG. 19 is a schematic structural diagram of another damper apparatus 510 disclosed herein. FIG. 20 and FIG. 21 are schematic structural diagrams of a centrifugal pendulum vibration absorbing apparatus 520. FIG. 22 is a sectional view of the centrifugal pendulum vibration absorbing apparatus 520 of FIG. 20 that is taken along a line AA. FIG. 20 illustrates a stationary state of the centrifugal pendulum vibration absorbing apparatus 520. FIG. 21 illustrates a swinging state of the centrifugal pendulum vibration absorbing apparatus 520. The same components of the damper apparatus 510 of FIG. 19 as the components of the damper apparatus 10 described above are represented by the same reference symbols to omit their detailed description. The damper apparatus 510 of FIG. 19 includes a driving member (input element) 511 and the driven member (output element) 15 as the rotational elements, and also includes, as the torque transfer element, a spring SP arranged between the driving member 511 and the driven member 15. The damper apparatus 510 further includes the centrifugal pendulum vibration absorbing apparatus 520 coupled to the driving member 511. In the damper apparatus 510 of FIG. 19, the centrifugal pendulum vibration absorbing apparatus 520 corresponds to the vibration damping apparatus disclosed herein instead of the damper apparatus 510.

As illustrated in FIG. 20 to FIG. 22, the centrifugal pendulum vibration absorbing apparatus 520 includes a torsional stiffness mechanism 530 coupled to the driving member 511, a torsional stiffness mechanism 540 coupled to the driving member 511, and a coupling mechanism 550 that couples the torsional stiffness mechanism 530 and the torsional stiffness mechanism 540 to each other.

The driving member 511 is identical to the damper apparatus 10 except that a plurality of (for example, four) guide holes 511h are provided at intervals in the circumferential direction. The guide hole 511h is an opening extending in a predetermined direction (upper right/lower left direction in FIG. 20 and FIG. 21). The guide hole 511h is formed symmetrically across a straight line passing through the rotation center RC of the driving member 511 and extending in a direction orthogonal to the extending direction of the guide hole 511h (hereinafter referred to as “reference line L81”; see a straight line indicated by a long dashed short dashed line in FIG. 20 and FIG. 21).

The torsional stiffness mechanism 530 includes a mass body 531, and a rivet 534 for coupling the mass body 531 and the driving member 511 to each other in a freely rotatable manner. The mass body 531 includes a columnar mass body base 532, and an arm 533 extending from the outer periphery of the mass body base 532 in a given direction (radially inward when the centrifugal pendulum vibration absorbing apparatus 520 is in the stationary state). The distal end of the arm 533 is coupled to the driving member 511 via the rivet 534 in a freely rotatable manner at a position on the reference line L81 that is spaced radially outward from the rotation center RC by a distance R8 and radially inward from the guide hole 511h by a distance (r8/2). Thus, the mass body 531 (arm 533) has a relationship of a revolute pair with the driving member 511. A center of gravity 531g of the mass body 531 is located at a position corresponding to the center of the mass body base 532 when viewed in the axial direction and spaced away from the rivet 534 (position of the revolute pair of the driving member 511 and the mass body 531) by a distance r8. The center of gravity 531g of the mass body 531 is located on a radially outermost side and at a position spaced radially outward from the guide hole 511h by the distance (r8/2) on the reference line L81 when the centrifugal pendulum vibration absorbing apparatus 520 is in the stationary state, shifted radially inward as the swing amount of the centrifugal pendulum vibration absorbing apparatus 520 (displacement from the stationary state) increases, and shifted radially outward as the swing amount of the centrifugal pendulum vibration absorbing apparatus 520 decreases. The mass body base 532 and the arm 533 are formed integrally, but may be formed separately and coupled to each other with a rivet or the like.

The torsional stiffness mechanism 540 includes a mass body 541, and a rivet 544 for coupling the mass body 541 and the driving member 511 to each other in a freely rotatable manner. The mass body 541 includes a columnar mass body base 542, and an arm 543 extending from the outer periphery of the mass body base 542 in a given direction (radially outward when the centrifugal pendulum vibration absorbing apparatus 520 is in the stationary state). The distal end of the arm 543 is coupled to the driving member 511 via the rivet 544 in a freely rotatable manner at a position on the reference line L81 that is spaced radially outward from the guide hole 511h by the distance (r8/2) (position spaced away from the rotation center RC by a distance (R8+r8)). Thus, the mass body 541 (arm 543) has a relationship of a revolute pair with the driving member 511. A center of gravity 541g of the mass body 541 is located at a position corresponding to the center of the mass body base 542 when viewed in the axial direction and spaced away from the rivet 544 (position of the revolute pair of the driving member 511 and the mass body 541) by the distance r8. The center of gravity 541g of the mass body 541 is located on a radially innermost side and at a position spaced radially inward from the guide hole 511h by the distance (r8/2) on the reference line L81 when the centrifugal pendulum vibration absorbing apparatus 520 is in the stationary state, shifted radially outward as the swing amount of the centrifugal pendulum vibration absorbing apparatus 520 (displacement from the stationary state) increases, and shifted radially inward as the swing amount of the centrifugal pendulum vibration absorbing apparatus 520 decreases. The mass body base 542 and the arm 543 are formed integrally, but may be formed separately and coupled to each other with a rivet or the like.

The coupling mechanism 550 includes a guide link 551, a guide link 552, a rivet 553 for coupling the guide link 551 and the mass body 531 to each other in a freely rotatable manner, a rivet 554 for coupling the guide link 551 and the mass body 541 to each other in a freely rotatable manner, and a pivot (rivet) 555 configured to move along the guide hole 511h formed in the driving member 511 and to couple the guide links 551 and 552 to each other in a freely rotatable manner.

The guide link 551 is formed so as to extend in a given direction. One end of the guide link 551 is coupled to the center of gravity 531g of the mass body 531 with the rivet 553 in a freely rotatable manner, and the other end of the guide link 551 is coupled to the guide link 552 and the pivot 555 with the pivot 555 in a freely rotatable manner. Thus, the guide link 551 has a relationship of a revolute pair with the mass body 531 at one end and a revolute pair with the guide link 552 and the pivot 555 at the other end.

The guide link 552 is formed so as to extend in a given direction. One end of the guide link 552 is coupled to the center of gravity 541g of the mass body 541 with the rivet 554 in a freely rotatable manner, and the other end of the guide link 552 is coupled to the guide link 551 and the pivot 555 with the pivot 555 in a freely rotatable manner. Thus, the guide link 552 has a relationship of a revolute pair with the mass body 541 at one end and a revolute pair with the guide link 551 and the pivot 555 at the other end.

As understood from FIG. 20 and FIG. 22, when the centrifugal pendulum vibration absorbing apparatus 520 is in the stationary state, the rivet 534 (fulcrum of the mass body 531), the center of gravity 541g of the mass body 541, and the rivet 554 are located at positions spaced away from the rotation center RC by the distance R8 on the reference line L81 when viewed in the axial direction. Further, the pivot 555 is located at a position spaced away from the rotation center RC by a distance (R8+r8/2). Still further, the center of gravity 531g of the mass body 531, the rivet 553, and the rivet 544 (fulcrum of the mass body 541) are located at positions spaced away from the rotation center RC by the distance (R8+r8).

In the centrifugal pendulum vibration absorbing apparatus 520, the torsional stiffness mechanism 530 functions similarly to the torsional stiffness mechanism 20 and the torsional stiffness mechanism 30 of the damper apparatus 10 of FIG. 1, and the torsional stiffness mechanism 540 functions similarly to the torsional stiffness mechanism 40 of the damper apparatus 10 of FIG. 1. Therefore, when the centrifugal pendulum vibration absorbing apparatus 520 is in the swinging state, that is, when the mass body 531 and the mass body 541 deviate from their positions in the stationary state of the centrifugal pendulum vibration absorbing apparatus 520, a force proportional to the square of the angular velocity Ω of the engine EG is applied to the torsional stiffness mechanism 530 in a direction in which the swing amount of the spring member 230 (deviation from the stationary state) is reduced similarly to the torsional stiffness mechanism 20 and the torsional stiffness mechanism 30, and a force proportional to the square of the angular velocity Ω of the engine EG is applied to the torsional stiffness mechanism 540 in a direction in which the swing amount of the torsional stiffness mechanism 540 is increased similarly to the torsional stiffness mechanism 40. Thus, it can be considered that the torsional stiffness mechanism 530 has a positive torsional stiffness k81 proportional to the square of the angular velocity Ω of the engine EG similarly to the torsional stiffness mechanism 20 and the torsional stiffness mechanism 30 and the torsional stiffness mechanism 540 has a negative torsional stiffness k82 proportional to the square of the angular velocity Ω of the engine EG similarly to the torsional stiffness mechanism 40. In the centrifugal pendulum vibration absorbing apparatus 520, it can be considered that the torsional stiffness mechanism 530 and the torsional stiffness mechanism 540 act on the driving member 511 in parallel. Therefore, an overall torsional stiffness k (=k81−k82) of the torsional stiffness mechanisms 530 and 540 can be reduced. Through the movement of the mass body 531 of the torsional stiffness mechanism 530 and the mass body 541 of the torsional stiffness mechanism 540, the pivot 555 coupled to the mass bodies 531 and 541 via the guide links 551 and 552 moves along the guide hole 511h. In this manner, a vibration having a phase opposite to that of the vibration transferred from the engine EG to the driving member 511 is applied to the driving member 511 from the centrifugal pendulum vibration absorbing apparatus 520, whereby vibrations of the driving member 511 and the driven member 15 can be absorbed (damped). Further, the rotation speed range of the engine EG in which high vibration damping performance can be exerted for the driving member 511 and the driven member 15 can be extended by appropriately setting the torsional stiffnesses k81 and k82 of the fourth and fifth torsional stiffness mechanisms 530 and 540.

The inventors have found that the equation of motion of the centrifugal pendulum vibration absorbing apparatus 520 can be represented by Expression (25). In Expression (25), “m81” represents a mass of the mass body 531, “m82” represents a mass of the mass body 541, “r8” represents each of the distance between the rivet 534 (fulcrum of the mass body 531) and the center of gravity 531g of the mass body 531 and the distance between the rivet 544 (fulcrum of the mass body 541) and the center of gravity 541g of the mass body 541, “R8” represents the distance between the rotation center RC and the fulcrum of the mass body 531 (position of the rivet 534), “48” represents a swing angle of each of the mass bodies 531 and 541 (each of an angle between the reference line L81 and the extending direction of the arm 533 and an angle between the reference line L81 and the extending direction of the arm 543), and “θ8” represents a rotation angle (rotational position) of the driving member 511 that is a vibration damping target. Assuming that the driving member 511 is rotating at a constant speed, a “second-order derivative of θ8” is a value “0” and a “first-order derivative of θ8” is the angular velocity of the engine EG in Expression (25). Assuming that the angle $8 is infinitesimal, that is, “sin ϕ8≈ϕ8 and cos ϕ8=1”, Expression (25) is transformed to obtain Expression (26). In Expression (26), it can be considered that a coefficient “{m81·R8−m82. (R8+r8)}·Ω²” of the swing angle ϕ8 of each of the mass bodies 531 and 541 corresponds to the overall torsional stiffness k (=k81−k82) of the torsional stiffness mechanisms 530 and 540. By using Expression (26), a natural frequency fn can be represented by Expression (27). Thus, the order n of the centrifugal pendulum vibration absorbing apparatus 520 can be represented by Expression (28). In the centrifugal pendulum vibration absorbing apparatus 520, it is necessary that the values in the radical signs of Expression (27) and Expression (28) be positive values. Therefore, it can be said that the function of a dynamic vibration absorber can be exerted when Expression (29) is satisfied.

$$\begin{matrix} [ Math . 13 ] & \\ [ ( m 81 - m 82 ) \cdot r {8}^{2} + \{ m 81 \cdot R 8 \cdot r 8 + m 82 \cdot ( R 8 + r 8 ) \cdot r 8 \} \cdot cos φ 8 ] \cdot \ddot{θ} 8 + ( m 81 + m 82 ) \cdot r {8}^{2} \cdot \ddot{φ} 8 + \{ m 81 \cdot R 8 \cdot r 8 - m 82 \cdot ( R 8 + r 8 ) \cdot r 8 \} \cdot \dot{θ} {8}^{2} \cdot sin φ 8 = 0 & ( 25 ) \\ ( m 81 + m 82 ) \cdot r 8 \cdot \ddot{φ} 8 + \{ m 81 \cdot R 8 - m 82 \cdot ( R 8 + r 8 ) \} \cdot {Ω}^{2} \cdot φ 8 = 0 & ( 26 ) \\ [ Math . 14 ] & \\ {f}_{n} = \frac{Ω}{2 \cdot π} \sqrt{\frac{( m 81 - m 82 ) \cdot R 8 - m 82 \cdot r 8}{( m 81 + m 82 ) \cdot r 8}} & ( 27 ) \\ n = \sqrt{\frac{( m 81 - m 82 ) \cdot R 8 - m 82 \cdot r 8}{( m 81 + m 82 ) \cdot r 8}} & ( 28 ) \\ [ Math . 15 ] & \\ \frac{m 81}{m 82} > ( 1 + \frac{r 8}{R 8} ) & ( 29 )\end{matrix}$$

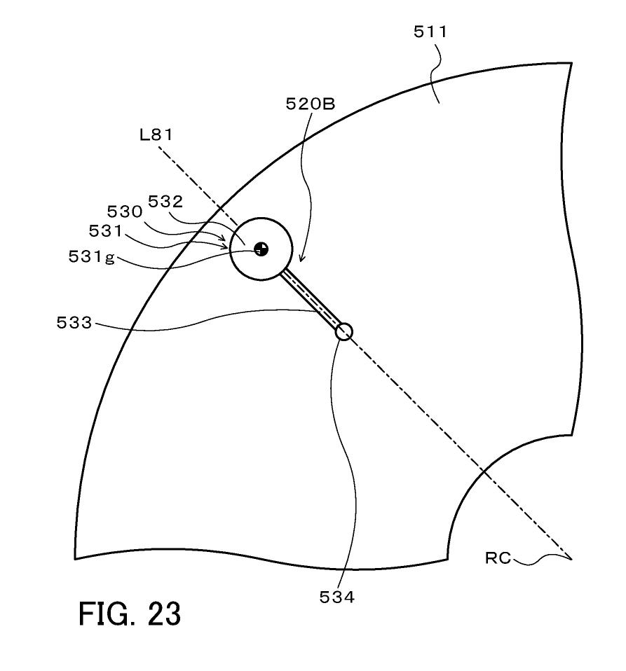

In the centrifugal pendulum vibration absorbing apparatus 520, the following effect is attained as well. As a comparative example, there is considered a centrifugal pendulum vibration absorbing apparatus 520B of FIG. 23, in which the torsional stiffness mechanism 530 of the centrifugal pendulum vibration absorbing apparatus 520 of FIG. 20 to FIG. 22 is provided but the guide hole 511h, the torsional stiffness mechanism 540, and the coupling mechanism 550 are omitted. In the centrifugal pendulum vibration absorbing apparatus 520 and the centrifugal pendulum vibration absorbing apparatus 520B, satisfactory vibration damping performance can be exerted when the orders of those apparatuses are equal to the order of the vibration transferred from the engine EG to the driving member 511. In the case of the centrifugal pendulum vibration absorbing apparatus 520B of FIG. 23, an order n′ of the centrifugal pendulum vibration absorbing apparatus 520 can be represented by Expression (30). In Expression (30), “r8” represents the distance between the rivet 534 and the center of gravity 531g of the mass body 531, and “R8” represents the distance between the rotation center RC and the fulcrum of the mass body 531 (position of the rivet 534). As described above, in the centrifugal pendulum vibration absorbing apparatus 520, the function of the dynamic vibration absorber can be exerted when Expression (29) is satisfied. Therefore, it can be said that the distance R8 can be increased by increasing the mass m82 of the mass body 541 within that range. For example, there is considered a case where the engine EG has two cylinders. In this case, it is necessary that the distance R8 and the distance r8 be set equal to each other in order that the order n′ of the centrifugal pendulum vibration absorbing apparatus 520B be equal to a value “1” (order of the vibration transferred from the engine EG to the driving member 511). Thus, the centrifugal pendulum vibration absorbing apparatus 520 may occupy the majority of the face (axial end face) of the driving member 511. When the order n of the centrifugal pendulum vibration absorbing apparatus 520 is set equal to the value “1”, it is demonstrated from Expression (28) that the distance R8 can be set larger than the distance r8 by appropriately setting the masses m81 and m82 of the mass bodies 531 and 541 (for example, when the ratio between the masses m81 and m82 of the mass bodies 531 and 541 is set to 2:1, “R8=4·r8” can hold). Thus, in the centrifugal pendulum vibration absorbing apparatus 520, the distance R8 can be set larger than that of the centrifugal pendulum vibration absorbing apparatus 520B of the comparative example. Accordingly, it is possible to secure a larger space on the face side of the inner peripheral portion of the driving member 511.

$$\begin{matrix}[ Math . 16 ] & \\ {n}^{′} = \sqrt{\frac{R 8}{r 8}} & ( 30 )\end{matrix}$$

In the damper apparatus 510 described above, the torsional stiffness mechanism 530 is structured to have the positive torsional stiffness k81 proportional to the square of the angular velocity Ω of the engine EG, but may be structured to have a constant positive torsional stiffness irrespective of the rotation speed of the engine EG.

In the damper apparatus 510 described above, the turbine runner 5 of the torque converter TC is fixed to the driven member 15. As indicated by a long dashed double-short dashed line in FIG. 19, the turbine runner 5 may be fixed to the driving member 511.

In the damper apparatus 510 described above, the centrifugal pendulum vibration absorbing apparatus 520 is coupled to the driving member 511, but may be coupled to the driven member 15.

As described above, a first vibration damping apparatus disclosed herein is summarized as follows. The first vibration damping apparatus is the vibration damping apparatus (10, 110) having the plurality of rotational elements including the input element (11) to which the torque from the engine (EG) is transferred, and the output element (15). The vibration damping apparatus (10, 110) includes the first torsional stiffness mechanism (20) arranged between the input element (11) and the output element (15) and having the positive torsional stiffness, and the second torsional stiffness mechanism (40, 140) configured to act in parallel to the first torsional stiffness mechanism (20) between the input element (11) and the output element (15) and having the negative torsional stiffness. The torsional stiffness of the second torsional stiffness mechanism (40, 140) increases on the negative side as the rotation speed of the engine (EG) increases.

In the first vibration damping apparatus disclosed herein, the first torsional stiffness mechanism having the positive torsional stiffness and the second torsional stiffness mechanism having the negative torsional stiffness act in parallel between the input element to which the torque from the engine is transferred and the output element. Thus, the overall torsional stiffness of the plurality of torsional stiffness mechanisms including the first torsional stiffness mechanism and the second torsional stiffness mechanism (corresponding to a combined spring rate in a case of springs) can be reduced. Further, the torsional stiffness of the second torsional stiffness mechanism increases on the negative side as the rotation speed of the engine increases. Thus, the overall torsional stiffness of the plurality of torsional stiffness mechanisms can appropriately change in response to the rotation speed of the engine. As a result, it is possible to extend the rotation speed range in which high vibration damping performance can be exerted for the input element to which the torque from the engine is transferred.

In the first vibration damping apparatus disclosed herein, the first torsional stiffness mechanisms (20, 240) and the second torsional stiffness mechanisms (40, 140, 250, 350, 450) may be arranged so as to be arrayed in the circumferential direction of the vibration damping apparatus (10, 110, 210, 310, 410). In this case, the first torsional stiffness mechanisms (20, 240) and the second torsional stiffness mechanisms (40, 140, 250, 350, 450) may be arranged so as to be alternately arrayed in the circumferential direction.

In the first vibration damping apparatus disclosed herein, the second torsional stiffness mechanism (40, 140) may include the negative coupling member (41) having the relationship of the revolute pair with one of the two rotational elements coupled via the second torsional stiffness mechanism (40, 140) and the sliding pair with the other of the two rotational elements. The center of gravity of the negative coupling member (41) may be shifted outward in the radial direction of the vibration damping apparatus (10, 110) as the relative torsion angle between the two rotational elements increases, and shifted inward in the radial direction as the relative torsion angle between the two rotational elements decreases. In this case, when the relative torsion angle is formed between the two rotational elements, the second torsional stiffness mechanism (40, 140) may operate so as to increase the relative torsion angle between the two rotational elements. Further, the two rotational elements may be formed annularly with different diameters and arranged concentrically. The negative coupling member (41) may be coupled to the one of the two rotational elements in a freely rotatable manner, and coupled to the other of the two rotational elements so as to freely rotate and to freely move in the extending direction of the negative coupling member (41). When the relative torsion angle between the two rotational elements is zero, the center of gravity of the negative coupling member (41) may be located on the inner side in the radial direction with respect to the positions where the negative coupling member (41) is coupled to the one of the two rotational elements and the other of the two rotational elements.

In the first vibration damping apparatus disclosed herein, the torsional stiffness of the first torsional stiffness mechanism (20) may increase on the positive side as the rotation speed of the engine (EG) increases. In this case, the first torsional stiffness mechanism (20) may include the positive coupling member (21) having the relationship of the revolute pair with one of the input element (11) and the output element (15) and the sliding pair with the other of the input element (11) and the output element (15). The center of gravity of the positive coupling member (21) may be shifted inward in the radial direction of the vibration damping apparatus (10, 110) as the relative torsion angle between the input element (11) and the output element (15) increases, and shifted outward in the radial direction as the relative torsion angle between the input element (11) and the output element (15) decreases. In this case, when the relative torsion angle is formed between the two rotational elements, the first torsional stiffness mechanism (20) may operate so as to reduce the relative torsion angle between the two rotational elements. Further, the input element (11) and the output element (15) may be formed annularly with different diameters and arranged concentrically. The positive coupling member (21) may be coupled to the one of the input element (11) and the output element (15) in a freely rotatable manner, and coupled to the other of the input element (11) and the output element (15) so as to freely rotate and to freely move in the extending direction of the positive coupling member (21). When the relative torsion angle between the input element (11) and the output element (15) is zero, the center of gravity of the positive coupling member (21) may be located on the outer side in the radial direction with respect to the positions where the positive coupling member (21) is supported by the one of the input element (11) and the output element (15) and the other of the input element (11) and the output element (15).

The first vibration damping apparatus disclosed herein may further include the third torsional stiffness mechanism (30) having the positive torsional stiffness. The plurality of rotational elements (11, 12, 15) may include the intermediate element (12) arranged between the input element (11) and the output element (15). The second torsional stiffness mechanism (40) may be arranged as one of intermediation between the input element (11) and the intermediate element (15) and intermediation between the intermediate element (12) and the output element (15). The third torsional stiffness mechanism (30) may be arranged as the other of the intermediation between the input element (11) and the intermediate element (12) and the intermediation between the intermediate element (12) and the output element (15).

In the first vibration damping apparatus disclosed herein, the second torsional stiffness mechanism (250, 350, 450) may be arranged so as to extend in the radial direction of the vibration damping apparatus (210, 310, 410).

In the first vibration damping apparatus disclosed herein in the aspect in which the second torsional stiffness mechanism is arranged so as to extend in the radial direction of the vibration damping apparatus, the inner rotational element (215), which is a rotational element located on the inner side in the radial direction out of the two rotational elements (212, 215) coupled via the second torsional stiffness mechanism (250), may have the guide hole (215h) formed so as to extend along the radial direction. The second torsional stiffness mechanism (250) may include the mass body (255) movable along the guide hole (215h), and the spring (251) coupled to the mass body (255) and the outer rotational element (212), which is a rotational element located on the outer side in the radial direction out of the two rotational elements (212, 215), and compressed shorter than its equilibrium length when the relative torsion angle between the two rotational elements (212, 215) is zero. In this case, the torsional stiffness of the second torsional stiffness mechanism (250) is the overall torsional stiffness of the second torsional mechanism (250) that is defined by including the spring rate of the spring (251).

In the first vibration damping apparatus disclosed herein in the aspect in which the second torsional stiffness mechanism is arranged so as to extend in the radial direction of the vibration damping apparatus, the inner rotational element (215), which is a rotational element located on the inner side in the radial direction out of the two rotational elements (212, 215) coupled via the second torsional stiffness mechanism (250), may have the guide hole (215h) formed so as to extend along the radial direction. The second torsional stiffness mechanism (350) may include the movement member (255) movable along the guide hole (215h), the spring (251) coupled to the movement member (255) and the outer rotational element (212), which is a rotational element located on the outer side in the radial direction out of the two rotational elements (212, 215), and compressed shorter than its equilibrium length when the relative torsion angle between the two rotational elements (212, 215) is zero, and the positional adjuster (360) configured to adjust the position of the movement member (255) in the radial direction. In this case, it is appropriate to adjust the position of the movement member so that the position of the movement member is shifted more radially outward as the rotation speed of the engine increases. In this case, the torsional stiffness of the second torsional stiffness mechanism (350) is the overall torsional stiffness of the second torsional mechanism (350) that is defined by including the spring rate of the spring (251).

In the first vibration damping apparatus disclosed herein in the aspect in which the second torsional stiffness mechanism is arranged so as to extend in the radial direction of the vibration damping apparatus, the second torsional stiffness mechanism (450) may include the variable pitch coil spring (451) in which the pitch of the active coil portion is variable. The variable pitch coil spring (451) may be compressed shorter than its equilibrium length when the relative torsion angle between the two rotational elements is zero. In this case, the pitch of the active coil portion of the variable pitch coil spring (451) may be smaller on the outer side in the radial direction than the inner side in the radial direction.

In the first vibration damping apparatus disclosed herein in the aspect in which the second torsional stiffness mechanism is arranged so as to extend in the radial direction of the vibration damping apparatus, the first torsional stiffness mechanism (240) may be arranged so as to extend in the circumferential direction of the vibration damping apparatus (210, 310, 410). In this case, the first torsional stiffness mechanism (240) may be the variable pitch coil spring in which the pitch of the active coil portion is variable. The pitch of the active coil portion of the variable pitch coil spring of the first torsional stiffness mechanism (240) may be smaller at the center of the first torsional stiffness mechanism (240) in its extending direction than both ends of the first torsional stiffness mechanism (240) in its extending direction.

The first vibration damping apparatus disclosed herein in the aspect in which the second torsional stiffness mechanism is arranged so as to extend in the radial direction of the vibration damping apparatus may further include the third torsional stiffness mechanism (220) and the fourth torsional stiffness mechanism (230) having the positive torsional stiffnesses. The plurality of rotational elements may include the intermediate element (213) arranged between the input element (211) and the output element (215). The third torsional stiffness mechanism (220) may be arranged between the input element (211) and the intermediate element (213). The fourth torsional stiffness mechanism (230) may be arranged between the intermediate element (213) and the output element (215). In this case, the first torsional stiffness mechanism (240) may operate when the relative torsion angle between the input element (211) and the output element (215) is equal to or larger than the predetermined torsion angle.

A second vibration damping apparatus (520) disclosed herein is summarized as follows. The second vibration damping apparatus (520) is the vibration damping apparatus (520) configured to damp the vibration of the rotational element (511) to which the torque from the engine (EG) is transferred. The vibration damping apparatus (520) includes the first torsional stiffness mechanism (530) coupled to the rotational element (511) in a freely rotatable manner and having the positive torsional stiffness, the second torsional stiffness mechanism (540) coupled to the rotational element (511) in a freely rotatable manner and having the negative torsional stiffness, and the coupling mechanism (550) that couples the first torsional stiffness mechanism (530) and the second torsional stiffness mechanism (540) to each other. The torsional stiffness of the second torsional stiffness mechanism (540) increases on the negative side as the rotation speed of the engine (EG) increases.

In the second vibration damping apparatus disclosed herein, the first torsional stiffness mechanism coupled in a freely rotatable manner to the rotational element to which the torque from the engine is transferred and having the positive torsional stiffness and the second torsional stiffness mechanism coupled to the rotational element in a freely rotatable manner and having the negative torsional stiffness are coupled to each other via the coupling mechanism. In this structure, it can be considered that the first torsional stiffness mechanism and the second torsional stiffness mechanism act on the rotational element in parallel. Therefore, the overall torsional stiffness of the plurality of torsional stiffness mechanisms including the first torsional stiffness mechanism and the second torsional stiffness mechanism can be reduced. Further, in this structure, when the first torsional stiffness mechanism and the second torsional stiffness mechanism deviate from their positions in the stationary state due to the occurrence of fluctuation in the rotation of the rotational element, a vibration having a phase opposite to that of the vibration transferred from the engine to the rotational element is applied to the rotational element from the vibration damping apparatus so that the first torsional stiffness mechanism may return to its position in the stationary state and the second torsional stiffness mechanism may increase the amount of the deviation. Thus, the vibration of the rotational element can be absorbed (damped). Further, the torsional stiffness of the second torsional stiffness mechanism increases on the negative side as the rotation speed of the engine increases. Thus, the overall torsional stiffness of the plurality of torsional stiffness mechanisms including the first torsional stiffness mechanism and the second torsional stiffness mechanism can appropriately change in response to the rotation speed of the engine. As a result, it is possible to extend the rotation speed range in which high vibration damping performance can be exerted for the rotational element to which the torque from the engine is transferred.

In the second vibration damping apparatus disclosed herein, the torsional stiffness of the first torsional stiffness mechanism (530) may increase on the positive side as the rotation speed of the engine (EG) increases.

In this case, the first torsional stiffness mechanism (530) may include the first mass body (531) having the relationship of the revolute pair with the rotational element (511) at a first position on the rotational element (511) and having the center of gravity that is located on the outer side in the radial direction of the vibration damping apparatus (520) with respect to the first position in the stationary state. The center of gravity of the first mass body (531) may be shifted inward in the radial direction as the swing amount of the rotational element (511) increases, and shifted outward in the radial direction as the swing amount of the rotational element (511) decreases. The second torsional stiffness mechanism (540) may include the second mass body (541) having the relationship of the revolute pair with the rotational element (511) at a second position on the rotational element (511) that is located on the outer side in the radial direction with respect to the first position and having the center of gravity that is located on the inner side in the radial direction with respect to the second position in the stationary state. The center of gravity of the second mass body (541) may be shifted outward in the radial direction as the swing amount of the rotational element (511) increases, and shifted inward in the radial direction as the swing amount of the rotational element (511) decreases.

In this case, the rotational element (511) may have the guide hole (511h) formed so as to extend in a predetermined direction. The first position may be located on the inner side in the radial direction with respect to the guide hole (511h). The second position may be located on the outer side in the radial direction with respect to the guide hole (511h). The coupling mechanism (550) may include the first link (551) having the relationship of the revolute pair with the first mass body (531) at one end, the second link (552) having the relationship of the revolute pair with the second mass body (541) at one end, and the pivot (555) configured to move along the guide hole (511h) and having the relationship of the revolute pair with the other end of the first link (551) and the other end of the second link (552).

In this case, the first link (551) may have the relationship of the revolute pair with the first mass body (531) at the position of the center of gravity of the first mass body (531). The second link (552) may have the relationship of the revolute pair with the second mass body (541) at the position of the center of gravity of the second mass body (541). Each of the distance between the first position and the center of gravity of the first mass body (531) and the distance between the second position and the center of gravity of the second mass body (541) may be a first distance. Each of the distance between the center of gravity of the first mass body (531) and the pivot (555) and the distance between the center of gravity of the second mass body (541) and the pivot (555) may be a second distance that is a half of the first distance.

Although the embodiment of the present disclosure has been described above, the present disclosure is not limited to the embodiment. It is understood that various embodiments may be adopted without departing from the spirit of the present disclosure.

### INDUSTRIAL APPLICABILITY

The present disclosure is applicable to, for example, industry for manufacturing the vibration damping apparatus.

1. A vibration damping apparatus comprising:
a plurality of rotational elements including an input element to which a torque from an engine is transferred, and an output;
a first torsional stiffness mechanism arranged between the input and the output and having a positive torsional stiffness; and
a second torsional stiffness mechanism configured to act in parallel to the first torsional stiffness mechanism between the input and the output and having a negative torsional stiffness, wherein
the negative torsional stiffness of the second torsional stiffness mechanism increases on a negative side as a rotation speed of the engine increases.

2. The vibration damping apparatus according to claim 1, wherein the first torsional stiffness mechanism and the second torsional stiffness mechanism are arranged so as to be arrayed in a circumferential direction of the vibration damping apparatus.

3. The vibration damping apparatus according to claim 2, wherein the first torsional stiffness mechanism and the second torsional stiffness mechanism are arranged so as to be alternately arrayed in the circumferential direction.

4. The vibration damping apparatus according to claim 1, wherein
the second torsional stiffness mechanism includes a negative coupling having a relationship of a revolute pair with one of two rotational elements of the plurality of rotational elements coupled via the second torsional stiffness mechanism and a sliding pair with the other of the two rotational elements of the plurality of rotational elements, and
a center of gravity of the negative coupling is shifted outward in a radial direction of the vibration damping apparatus as a relative torsion angle between the two rotational elements increases, and shifted inward in the radial direction as the relative torsion angle between the two rotational elements decreases.

5. The vibration damping apparatus according to claim 4, wherein, when the relative torsion angle is formed between the two rotational elements, the second torsional stiffness mechanism operates so as to increase the relative torsion angle between the two rotational elements.

6. The vibration damping apparatus according to claim 4, wherein
the two rotational elements are formed annularly with different diameters and arranged concentrically,
the negative coupling is coupled to the one of the two rotational elements in a freely rotatable manner, and coupled to the other of the two rotational elements so as to freely rotate and to freely move in an extending direction of the negative coupling, and
when the relative torsion angle between the two rotational elements is zero, the center of gravity of the negative coupling is located on an inner side in the radial direction with respect to positions where the negative coupling is supported by the one of the two rotational elements and the other of the two rotational elements.

7. The vibration damping apparatus according to claim 1, wherein the positive torsional stiffness of the first torsional stiffness mechanism increases on a positive side as the rotation speed of the engine increases.

8. The vibration damping apparatus according to claim 7, wherein
the first torsional stiffness mechanism includes a positive coupling having a relationship of a revolute pair with one of the input and the output and a sliding pair with the other of the input and the output, and
a center of gravity of the positive coupling is shifted inward in a radial direction of the vibration damping apparatus as a relative torsion angle between the input and the output increases, and shifted outward in the radial direction as the relative torsion angle between the input and the output decreases.

9. The vibration damping apparatus according to claim 8, wherein, when the relative torsion angle is formed between two rotational elements of the plurality of rotational elements, the first torsional stiffness mechanism operates so as to reduce the relative torsion angle between the two rotational elements.

10. The vibration damping apparatus according to claim 8, wherein
the input and the output are formed annularly with different diameters and arranged concentrically,
the positive coupling is coupled to the one of the input and the output in a freely rotatable manner, and coupled to the other of the input and the output so as to freely rotate and to freely move in an extending direction of the positive coupling, and
when the relative torsion angle between the input and the output is zero, the center of gravity of the positive coupling is located on an outer side in the radial direction with respect to positions where the positive coupling is coupled to the one of the input and the output and the other of the input and the output.

11. The vibration damping apparatus according to claim 1, further comprising a third torsional stiffness mechanism having a positive torsional stiffness, wherein
the plurality of rotational elements include an intermediate element arranged between the input and the output,
the second torsional stiffness mechanism is arranged as one of intermediation between the input and the intermediate element and intermediation between the intermediate element and the output, and
the third torsional stiffness mechanism is arranged as the other of the intermediation between the input and the intermediate element and the intermediation between the intermediate element and the output.

12. The vibration damping apparatus according to claim 1, wherein the second torsional stiffness mechanism is arranged so as to extend in a radial direction of the vibration damping apparatus.

13. The vibration damping apparatus according to claim 12, wherein
an inner rotational element, which is a rotational element located on an inner side in the radial direction out of two rotational elements of the plurality of rotational elements coupled via the second torsional stiffness mechanism, has a guide hole formed so as to extend along the radial direction, and
the second torsional stiffness mechanism includes a mass body movable along the guide hole, and a spring coupled to the mass body and an outer rotational element, which is a rotational element located on an outer side in the radial direction out of the two rotational elements, and compressed shorter than an equilibrium length of the outer rotational element when a relative torsion angle between the two rotational elements is zero.

14. The vibration damping apparatus according to claim 12, wherein
an inner rotational element, which is a rotational element located on an inner side in the radial direction out of two rotational elements of the plurality of rotational elements coupled via the second torsional stiffness mechanism, has a guide hole extending along the radial direction, and
the second torsional stiffness mechanism includes a movement member movable along the guide hole, a spring coupled to the movement member and an outer rotational element, which is a rotational element located on an outer side in the radial direction out of the two rotational elements, and compressed shorter than an equilibrium length of the outer rotational element when a relative torsion angle between the two rotational elements is zero, and a positional adjuster configured to adjust a position of the movement member in the radial direction.

15. The vibration damping apparatus according to claim 13, wherein the torsional stiffness of the second torsional stiffness mechanism is an overall torsional stiffness of the second torsional mechanism that is defined by including a spring rate of the spring.

16-22. (canceled)

23. A vibration damping apparatus configured to damp a vibration of a rotational element to which a torque from an engine is transferred, the vibration damping apparatus comprising:
a first torsional stiffness mechanism coupled to the rotational element in a freely rotatable manner and having a positive torsional stiffness;
a second torsional stiffness mechanism coupled to the rotational element in a freely rotatable manner and having a negative torsional stiffness; and
a coupler that couples the first torsional stiffness mechanism and the second torsional stiffness mechanism to each other, wherein
the torsional stiffness of the second torsional stiffness mechanism increases on a negative side as a rotation speed of the engine increases.

24-27. (canceled)
